(19) United States
(12) Patent Application Publication
(10) Pub. No.: US 2024/0394806 A1
(43) Pub. Date: Nov. 28, 2024

(54) SATELLITE DATA FOR AQUACULTURE RISK AND DISEASE MANAGEMENT

(71) Applicant: BASF SE, Ludwigshafen Am Rhein (DE)

(72) Inventor: Peer STAEHLER, Ludwigshafen am Rhein (DE)

(21) Appl. No.: 18/694,515

(22) PCT Filed: Oct. 5, 2022
(86) PCT No.: PCT/EP2022/077635

§ 371 Date: Mar. 22, 2024

(30) Foreign Application Priority Data
Oct. 6, 2021 (EP) 21201141.5

(51) Int. Cl. G06Q 50/02; A01K 63/04; G06Q 10/0637

(52) U.S. Cl. CPC G06Q 50/02; G06Q 10/0637; A01K 63/042

(57) ABSTRACT

A computer-implemented aquaculture farm management method is disclosed. The method includes the following steps: a) obtaining, by at least one computer, at least one aerial parameter of use of at least one aquaculture pond of at least one aquaculture farm; b) obtaining, by the computer, at least one regional management parameter of at least one region regionally associated with the aquaculture farm; and c) determining, by the computer, at least one management demand signal for the aquaculture pond on the basis of the aerial parameter of use and the regional management parameter. Further disclosed are a computer program, a computer or computer network, a computer readable storage medium and an aquaculture farm management system.

### TECHNICAL FIELD

The invention relates to a computer-implemented aquaculture farm management method and to an aquaculture farm management system. The methods and devices of the present invention, as an example, may be used in the field of breeding aquatic organisms, such as shrimp or other aquatic animals. Other applications, such as the cultivation of aquatic plants, however, are also feasible.

### BACKGROUND ART

Aquaculture is usually understood to refer to the farming of aquatic organisms, such as fish, molluscs, crustaceans and aquatic plants. The largest part of aquacultural farming, specifically shrimp farming, takes place in Asia, particularly in Thailand and China, and Latin America, particularly in Ecuador, Brazil and Mexico. Sun et al. (Zhe Sun, Juhua Luo, Jingzhicheng Yang, Qiuyan Yu, Li Zhang, Kun Xue and Lirong Lu; “Nation-Scale Mapping of Coastal Aquaculture Ponds with Sentinel-1 SAR Data Using Google Earth Engine”, Remote Sensing 2020, 12(18), 3086) present in their study a Google Earth Engine (GEE) application for mapping coastal aquaculture ponds at a national scale with a novel classification scheme using Sentinel-1 time series data. They report that the geometric metrics considering the spatial variation of radar backscatter patterns were effective at distinguishing aquaculture ponds from other water bodies. Using this approach, they classified aquaculture ponds for the full extent of the coastal area in Vietnam with an overall accuracy of 90.16%.

Falconer et al. (Lynne Falconer, Anne Lise Middelboe, Hanne Kaas, Lindsay G. Ross and Trevor C. Telfer; “Use of geographic information systems for aquaculture and recommendations for development of spatial tools”, Reviews in Aquaculture (2020) 12, 664-677) report that Geographic Information Systems (GIS) are used for investigation, analysis and modelling of aquaculture. In their study, Falconer et al. present a quantitative analysis of primary scientific literature, focusing on over 200 studies, to enable a comprehensive overview of the application of GIS and the trends associated with its use for aquaculture. Further, recommendations regarding the developing of GIS-based tools for aquaculture are given.

Despite the many advantages of the methods and devices developed to manage aquaculture farming numerous challenges remain to be tackled. Thus, as an example, aquaculture farms, specifically those situated in the open air, are exposed to a multitude of influences, which generally are difficult to control or to foresee.

### Problem to be Solved

It is therefore an objective of the present invention to provide an aquaculture farm management method and an aquaculture farm management system, which at least partially avoid the drawbacks and disadvantages of known aquaculture farm management methods and aquaculture farm management systems. Specifically, it is desirable to provide an aquaculture farm management method and an aquaculture farm management system that are applicable easily and cost efficiently to one or several individual aquaculture ponds of an aquaculture farm.

### SUMMARY

This problem is addressed by a computer-implemented aquaculture farm management method and an aquaculture farm management system with the features of the independent claims. Advantageous embodiments, which might be realized in an isolated fashion or in any arbitrary combinations, are listed in the dependent claims as well as throughout the specification.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, notwithstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In a first aspect of the present invention, a computer-implemented aquaculture farm management method is proposed. The method comprises the following steps, preferably in the indicated order. A different order, however, may be possible. Further, one or several or all steps may be performed once or repeatedly. Furthermore, two or several or all of the steps may be performed successively or in a fully or partially temporally overlapping fashion. The method may, in addition to the indicated steps, comprise further steps that are not listed.

The method comprises the following steps:
a) obtaining, by at least one computer, at least one aerial parameter of use of at least one aquaculture pond of at least one aquaculture farm;
b) obtaining, by the computer, at least one regional management parameter of at least one region regionally associated with the aquaculture farm; and
c) determining, by the computer, at least one management demand signal for the aquaculture pond on the basis of the aerial parameter of use and the regional management parameter.

The term “computer” as used herein is a broad term and is to be given its ordinary and customary meaning to a person of ordinary skill in the art and is not to be limited to a special or customized meaning. The term specifically may refer, without limitation, to a device or to a combination or network of devices having at least one data processing means such as at least one processor. The computer, additionally, may comprise one or more further components, such as at least one of a data storage device, an electronic interface or a human-machine interface.

The term “computer-implemented method” as used herein is a broad term and is to be given its ordinary and customary meaning to a person of ordinary skill in the art and is not to be limited to a special or customized meaning. The term specifically may refer, without limitation, to a method involving at least one computer and/or at least one computer network. The computer and/or computer network may comprise at least one processor, which is configured for performing at least one of the method steps of the method according to the present invention. Specifically, each of the method steps, in particular method steps a), b) and c), may be performed by the computer and/or computer network. The method may be performed completely automatically, specifically without user interaction.

The term “aquaculture” as used herein is a broad term and is to be given its ordinary and customary meaning to a person of ordinary skill in the art and is not to be limited to a special or customized meaning. The term specifically may refer, without limitation to the breeding, rearing or fattening of aquatic organisms such as aquatic plants or aquatic animals. In particular, the aquaculture may be used to breed fish, molluscs, shellfish or crustaceans, including shrimp and/or prawn.

The term “aquaculture farm” as used herein is a broad term and is to be given its ordinary and customary meaning to a person of ordinary skill in the art and is not to be limited to a special or customized meaning. The term specifically may refer, without limitation to an area used or des-ignated for aquaculture. Thus, the aquaculture farm may comprise at least one aquaculture pond. Specifically, the aquaculture farm may comprise a plurality of aquaculture ponds, such as at least 2, at least 3, at least 10, at least 50 or at least 100 aquaculture ponds. The aquaculture farm may comprise further areas surrounding or bordering on the at least one aquaculture pond and/or areas situated between the aquaculture ponds of the aquaculture farm. Such areas may be used for maintenance purposes. In particular, they may comprise infrastructure in connection with the aquaculture farming such as channels, pipes, pumps, reservoirs, floodgates or other means of water management, feeding devices, fences or other security means, sensor devices. Other examples are feasible. In particular, the aquaculture pond and the further areas may together form a coherent area of the aquaculture farm.

The term “aquaculture pond” as used herein is a broad term and is to be given its ordinary and customary meaning to a person of ordinary skill in the art and is not to be limited to a special or customized meaning. The term specifically may refer, without limitation to an area used for aquaculture or to an area intended to be used for aquaculture, such as an area of a basin or the basin itself. Specifically, the aquaculture pond may comprise a waterbody, in particular an artificial waterbody. The waterbody of the aquaculture pond may contain aquatic organisms intended for aquaculture. The waterbody of the aquaculture pond may, however, also be free or essentially free of aquatic organisms intended for aquaculture, e.g. in a state of preparation of the waterbody for a subsequent introduction and breeding of aquatic organisms. The aquaculture pond may further comprise dikes, walls or the like configured to enclose or contain the waterbody. The aquaculture pond may, however, also be devoid of water. Thus, the aquaculture pond may be drained, e.g. for harvesting the farmed aquatic organisms, for a fallow period, for maintenance or other reasons. The aquaculture pond may, in particular, have a rectangular or polygonal shape. The aquaculture pond may specifically be situated in the open air. The aquaculture pond and/or the aquaculture farm as a whole may be visible from above. The aquaculture pond may also be simply referred to as pond. The aquaculture pond may specifically be used for growing one or more of shellfish or crustaceans, preferably shrimp and/or prawn.

The term “aquaculture farm management” as used herein is a broad term and is to be given its ordinary and customary meaning to a person of ordinary skill in the art and is not to be limited to a special or customized meaning. The term specifically may refer, without limitation to actions, decisions and/or plannings that are taken as part of running, directing or organizing an aquaculture farm. In particular, the actions, decisions or the planning may be taken with the aim of achieving a desired result that may be advantageous for the farming effort. The desired result may be various. Thus, the actions, decisions or the planning may aim at establishing or main-taining favorable conditions for the rearing of the aquatic organisms of the aquaculture, such as an amount or timing of feed, favorable water conditions e.g. regarding temperature, salinity or oxygen content, the administration of drugs or other conditions. The managing of the aquaculture farm may further aim at an efficient organization of the aquaculture farm, protection from potential danger, such as the intrusion of disease, avoiding potential damage, such as by flooding. A variety of further desired results is feasible. Actions regarding the aquaculture pond that are taken as part of the aquaculture farm management may also be referred to as “aquaculture pond management actions”.

The term “obtaining” as used herein is a broad term and is to be given its ordinary and customary meaning to a person of ordinary skill in the art and is not to be limited to a special or customized meaning. The term specifically may refer, without limitation, to an arbitrary process of determining, at least one data element, e.g. information such as electronic data and/or an arbitrary electronic signal comprising information, for example generated by using at least one electronic device, e.g. a computer. Specifically, obtaining may refer to a determination process, such as by one or more of a generating process, e.g. by a computer or computer network using at least one algorithm applied to at least one data set; a measuring process, by acquiring measurement data, e.g. from a sensor or other electronic device; receiving and/or retrieving, such as via at least one interface of the computer or computer network. In particular, the data element obtained by the computer may be produced and/or created by the computer itself. Additionally or alternatively, the data element may be made available to the computer by a further means, e.g. a further electronic device such as a sensor and/or a further computer. The data element obtained by the computer may further be made available by the computer to at least one further computer or electronic device for further use.

The term “obtaining at least one aerial parameter of use” as used herein is a broad term and is to be given its ordinary and customary meaning to a person of ordinary skill in the art and is not to be limited to a special or customized meaning. The term specifically may refer, without limitation, to an arbitrary process of determining the at least one aerial parameter of use, such as by generating, measuring receiving and/or retrieving the aerial parameter of use. Specifically, the aerial parameter of use obtained by the computer may be determined by the computer, e.g. by being generated on the basis of information such as aerial sensor data that may be interpreted or evaluated by the computer in a predetermined manner, such as by at least one algorithm. Additionally or alternatively, the computer may obtain the aerial parameter of use by retrieving it or by receiving it from another source.

Similarly, the term “obtaining at least one regional management parameter” as used herein is a broad term and is to be given its ordinary and customary meaning to a person of ordinary skill in the art and is not to be limited to a special or customized meaning. The term specifically may refer, without limitation, to an arbitrary process of determining the at least one regional management parameter, such as by generating, measuring, receiving and/or retrieving, the regional management parameter. Specifically, the regional management parameter obtained by the computer may be generated or determined by the computer, e.g. by interpreting or evaluating data such as aerial sensor data or other data, e.g. measurement data from at least one sensor device. Additionally of alternatively, the regional management parameter may be obtained by the computer by retrieving it or by receiving it from another source, e.g. from a sensor device. Thus, the regional management parameter may be obtained by the computer e.g. by retrieving it from an electronic source, such as a database or another electronic source.

The term “parameter of use” as used herein is a broad term and is to be given its ordinary and customary meaning to a person of ordinary skill in the art and is not to be limited to a special or customized meaning. The term specifically may refer, without limitation to information regarding an arbitrary property, quality, state or condition of an object, wherein said property, quality, state or condition has the potential to affect or influence the use or the usability of the object. The parameter of use may describe a property, quality, state or condition of the object itself as well as a presence or absence of structures or elements relating to the use of the object. As an example, the parameter of use of the aquaculture pond may refer to the water level of the pond, e.g. the pond is filled with water or is drained. The parameter of use may refer to the aeration status of the pond, e.g. the pond being aerated, in particular at a certain intensity and/or by a certain aeration device, or not aerated. The parameter of use may refer to the presence or absence of aeration devices in a particular pond. The parameter of use may refer to the presence or absence of aquafarming infrastructure elements which affect the use or usability of the aquaculture pond. Specifically, the parameter of use may refer to the presence or absence of channels, pipes, draines and/or reservoirs in connection with the aquaculture pond, the use of a natural water body as feed water source or the common use of a feed water source with a further aquaculture pond. The parameter of use may refer to a location of the aquaculture pond or its aquaculture farm, e.g. its exact geographic location or its location in at least one predetermined geographic region or within at least one predefined distance to at least one reference point and/or location, such as a natural water body, a mountain and/or a further aquaculture pond. Such an information regarding the location of the aquaculture pond may affect the use of the aquaculture pond in numerous ways. Thus, as an example, an outbreak of disease at an aquaculture farm may easily lead to infections at other aquaculture farms in its close vicinity, in particular if common feed water sources are used, such as a particular river. Further, weather conditions or other natural phenomena may usually have locally restricted effects, which may also influence aquaculture farms. Other examples are feasible.

The term “aerial parameter of use” as used herein is a broad term and is to be given its ordinary and customary meaning to a person of ordinary skill in the art and is not to be limited to a special or customized meaning. The term specifically may refer, without limitation, to a parameter of use that is determined using aerial sensor data. The term “aerial sensor data” as used herein is a broad term and is to be given its ordinary and customary meaning to a person of ordinary skill in the art and is not to be limited to a special or customized meaning. The term specifically may refer, without limitation to data acquired by at least one air-based sensor. In particular, the aerial sensor data may be or may comprise at least one image or at least one map. The image and the map acquired by the air-based sensor may also be referred to as aerial image and aerial map, respectively.

The term “air-based sensor” as used herein is a broad term and is to be given its ordinary and customary meaning to a person of ordinary skill in the art and is not to be limited to a special or customized meaning. The term specifically may refer, without limitation to a sensor that is situated in an aboveground position. In particular, the air-based sensor may be situated in an aboveground position above an object, wherein the air-based sensor is configured to sense at least one quality, feature or property of said object, for instance, by generating an image of the object. Specifically, the air-based sensor may be situated in an aboveground position remote from the object. The aerial parameter of use may particularly be based on aerial sensor data acquired by at least one air-based sensor that may be located on a satellite, an airplane or a drone. Thus, the sensor data may be acquired at a considerable distance from the object, such as at a distance in the range from 1 m to 50000 km, preferably from 20 m to 5000 km, more preferably from 30 m to 2000 km. Thus, the air-based sensor may be situated in an aboveground position, wherein the aboveground position and/or its surroundings may be devoid of air. Additionally or alternatively, the aerial parameter of use may particularly be based on aerial sensor data acquired by at least one air-based sensor that may be mounted on a support device that is in contact with the ground. The support device may for example comprise at least one of: a pole; a stake; a post; a pylon. In particular, the support device may be static and may be stably connected to the ground. Alternatively, the support device may be movable or relocatable for example by means of wheels. Furthermore, the air-based sensor that may be mounted on a drone, such that the air-based sensor may be movable or relocatable by controlling the drone. The aerial sensor data acquired by an air-based sensor located in the above-given distance range from the object may also be referred to as “remote aerial sensor data”.

The term “regional management parameter” as used herein is a broad term and is to be given its ordinary and customary meaning to a person of ordinary skill in the art and is not to be limited to a special or customized meaning. The term specifically may refer, without limitation to a state, a condition, a property and/or an event that may affect the running, directing or organizing of the aquaculture farm, e.g. of the at least one pond. The regional management parameter may specifically have the potential to influence or affect the aquaculture farm and/or pond, in particular the farming effort, outcome or success of the aquaculture pond. The state, condition, property and/or event may originate from and/or becomes discernable at a location and/or area that is distant from the aquaculture farm to which the aquaculture pond belongs and/or borders on the aquaculture farm. In particular, it may be advantageous or beneficial to take into account the state, condition, property and/or event in the management of the aquaculture farm. Specifically in a situation, in which the aquaculture pond may be situated in the open air, it may be exposed to external influences, e.g. environmental influences, meteorological influences or natural phenomena, which may reduce the farming success or even spoil the farming efforts, e.g. by bringing about conditions lethal to the farmed aquatic organisms. The regional management parameter may take account of such states, conditions, properties and/or events. As an example, the regional management parameter may refer to a meteorological situation or its effects such as wind conditions, rainfall, water level, tidal level or wave height, which may e.g. cause flooding. As a further example, the regional management parameter may refer to a state, a condition, a property or an event regarding an aquaculture pond of a further aquaculture farm, e.g. a sup-posed or actual outbreak of a disease. Further examples of regional management parameters are feasible. The regional management parameter may for example be expressed or reflected in at least one measured value, a course of measured values, specifically a time course of measured values, a measurement curve or table of measured values. Additionally of alternatively, the regional measurement parameter may comprise information in the form of image data, such as aerial sensor data, and/or in verbal format such as in a text, for example a text from a newsfeed, and/or in the form of numerical values.

The term “region” as used herein is a broad term and is to be given its ordinary and customary meaning to a person of ordinary skill in the art and is not to be limited to a special or customized meaning. The term specifically may refer, without limitation to a coherent area, a territory or a zone, specifically a geographic location. In particular, the region may be a coherent area that is characterized by a property that is common to the area as a whole. Such a property may e.g. be a maximum distance to a reference point, e.g. the aquaculture farm, or a topographical property such as the presence of mountains or the sea. Specifically, the region may be regionally associated with the aquaculture farm.

The term “regionally associated with an aquaculture farm” as used herein is a broad term and is to be given its ordinary and customary meaning to a person of ordinary skill in the art and is not to be limited to a special or customized meaning. The term specifically may refer, without limitation to a region that due to its geographical location may be relevant to the aquaculture farm, e.g. due to a potential effect on at least one aspect, e.g. at least one pond, of the aquaculture farm. The region that is regionally associated with an aquaculture farm may border on the aquaculture farm or may be situated distant from the aquaculture farm. In particular, the region, specifically a geographic location comprised by the region, which is regionally associated with the aquaculture farm, may be situated at a maximum distance or less from the aquaculture farm, wherein said maximum distance may be 1000 km, preferably 500 km, more preferably 200 km, more preferably 50 km and most preferably 10 km. Thus, a plurality of regions may be regionally associated with a single aquaculture farm. Such regions may cover areas at distinct geographical sites and/or with distinct properties, such as one region comprising the course of a river that may function as feed water source. Another region may comprise the sea and/or a costal region close to the aquaculture farm. Another region may comprise further aquaculture farms in a vicinity to the aquaculture farm in question. Further regions that are regionally associated with an aquaculture farm are feasible.

The term “determining the management demand signal” as used herein is a broad term and is to be given its ordinary and customary meaning to a person of ordinary skill in the art and is not to be limited to a special or customized meaning. The term specifically may refer, without limitation to an arbitrary process of generating at least one management demand signal. The management demand signal may be generated by the computer using at least one algorithm. As part of the algorithm, data may be evaluated or interpreted in a predetermined manner. Additionally or alternatively, as part of determining the management demand signal, the management demand signal may be chosen from a predetermined data set of management demand signals, in particular signals, in a predetermined manner. The term “management demand signal” as used herein is a broad term and is to be given its ordinary and customary meaning to a person of ordinary skill in the art and is not to be limited to a special or customized meaning. The term specifically may refer, without limitation to an arbitrary electronic signal comprising information regarding at least one farming instruction, such as a handling suggestion, e.g. relating to the handling of at least one infrastructure element of the aquaculture farm. In particular the management demand signal may comprise information on potentially beneficial changes and/or adaptions in the aquaculture farm management, such as on possible adjustments of at least one parameter of the aquaculture farm management e.g. feeding, water quality, harvest time or use of floodgates. Other alternatives are possible. Specifically, the management demand signal may identify or indicate a possible requirement or need for changing or adjusting a specific management parameter of the aquaculture farm.

The management demand signal is determined on the basis of the aerial parameter of use and the regional management parameter. Specifically, the management demand signal may be determined taking into account both the aerial parameter of use and the regional management parameter. Specifically, for determining the management demand signal, the computer may evaluate data and/or information comprised by the aerial parameter of use and data and/or information comprised by the regional management parameter. While the aerial parameter of use may comprise information on the aquaculture pond, specifically in connection with its use, the regional management parameter may comprise information on a state, a condition, a property and/or an event, which may be relevant for the aquaculture farm and which may originate from one of the regions regionally associated to the aquaculture farm in which the aquaculture pond is situated. For determining the management demand signal the information of the aerial parameter of use and the regional management parameter may be evaluated, interpreted and connected to generate and/or deduce further information, which may be comprised in the management demand signal. As an example, the aerial parameter of use obtained in step a) may indicate that a particular aquaculture pond uses a particular river as feed water source. The aerial parameter of use of the pond may indicate the presence of floodgates. The regional management parameter obtained in step b) may comprise information on rainfalls in a region regionally associated with the aquaculture farm, wherein the region comprises said river. The computer determining the management demand signal in step c) may evaluate the information, e.g. by comparing the measured rainfall to at least one threshold value and in case the threshold value is exceeded, a management demand signal may be generated comprising instructions to close the floodgate and/or to disconnect the aquaculture pond from the river. The management demand signal may be made available to a user. Additionally or alternatively, the management demand signal may be made available to at least one control device as explained further below.

The management demand signal may comprise control information. The management demand signal specifically may comprise control information on at least one of the following aquaculture pond management actions: an adjustment of feed composition; an adjustment of feed amount; an adjustment of feed timing; an adjustment of medication dispensation; an adjustment of aeration; an adjustment of filtration; an adjustment of salinity; an adjustment of water flow; an adjustment of influx volume; an adjustment of outflux volume; an adjustment of timing of animal release into the aquaculture pond; an adjustment of harvest time, specifically a harvesting of the aquaculture pond at a predetermined time or in a predetermined time range; an adjustment of a status of at least one tide gate or floodgate, specifically a closure or an opening of the tide gate or floodgate; an adjustment of a feed water source, specifically a change of a feed water source from a natural water body like a river to a reservoir or vice versa; a use or removal of at least one protection device, specifically at least one covering device.

The term “control information” as used herein is a broad term and is to be given its ordinary and customary meaning to a person of ordinary skill in the art and is not to be limited to a special or customized meaning. The term specifically may refer, without limitation to at least one piece of information in electronic form, e.g. at least one electronic signal comprising information, wherein the information is adapted to regulate or control at least one control device, specifically at least one actuator device of the control device. The term “control device” as used herein is a broad term and is to be given its ordinary and customary meaning to a person of ordinary skill in the art and is not to be limited to a special or customized meaning. The term specifically may refer, without limitation, to an arbitrary electronic device configured to be controlled via at least one electronic signal comprising control information. The control device may specifically comprise at least one actuator device that may be controllable via the control information. The control device may control or regulate at least one state, condition or process specifically via the actuator device, more specifically via at least one control variable of the actuator device. As a result of being controlled by the control information, the actuator device may specifically perform at least one mechanical movement, e.g. an opening or closing of a valve or a floodgate or the dispensation of food or medication. A large number of actuator devices may be conceivable.

The aquaculture farm management method may further comprise:
d) providing, to at least one control device, specifically at least one control device of the aquaculture farm, the management demand signal.

Specifically, the management demand signal may be provided to the control device by the computer. Specifically, the management demand signal may be transmitted to the control device, for example via at least one wireless transmission and/or via at least one physical connection, such as at least one cable. Specifically, the control device may receive the control information as part of the management demand signal. The control device may comprise the actuator device. The actuator device may form a physical entity together with the control device. Alternatively, the actuator device may be embodied as a separate electronic device connected to the control device such that the control information may be transmitted, e.g. via wireless transmission or via a physical connection, such as via at least one cable.

The method may further comprise:
e) automatically controlling the control device according to the management demand signal.

Specifically, the control device may be automatically controlled according to the management demand signal, in particular via the control information that may form part of the management demand signal. The term “automatically” as used herein is a broad term and is to be given its ordinary and customary meaning to a person of ordinary skill in the art and is not to be limited to a special or customized meaning. The term specifically may refer, without limitation, to a process, which is performed completely by means of at least one computer, in particular without manual action and/or interaction with a user.

The method may further comprise:
f) informing a user, by at least one user device of the control device, about the management demand signal.

The control device may comprise the at least one user device. Specifically, in step f) the user may be informed about the management demand signal by displaying the management demand signal by at least one display of the user device, e.g. of the control device. The term “user device” as used herein is a broad term and is to be given its ordinary and customary meaning to a person of ordinary skill in the art and is not to be limited to a special or customized meaning. The term specifically may refer, without limitation, to an arbitrary electronic device configured for interaction with a user. For example, the user device may be configured to present information to or share information with the user. The user device may further be configured to receive information from the user. The user device may be a feature to interact visually with the user, such as a display, or a feature to interact acoustically with the user. The user device may particularly be adapted to inform the user about the management demand signal.

Step f) may further comprise instructing the user for performing at least one action according to the management demand signal, particularly an aquaculture pond management action. In step f) the user may furthermore be instructed to perform the at least one action by providing guidance to the user by an augmented reality element of the user device, such as by a virtual reality headset, e.g. by superimposing guidance information in a field of view of the user. As an example, the user may receive information by the augmented reality element regarding the adjustment of control elements, such as a button that needs to be pressed or a cog that needs to be turned, to perform a management action in accordance with the management demand signal, such as the closing of the floodgate.

The control device may comprise at least one actuator device. The term “actuator device” as used herein is a broad term and is to be given its ordinary and customary meaning to a person of ordinary skill in the art and is not to be limited to a special or customized meaning. The term specifically may refer, without limitation, to at least one electronic device adapted to perform at least one action that may affect a state or a process that is to be controlled. The control device may comprise the actuator device. The actuator device may be controlled by the control information. A large variety of actuator devices is feasible. In particular, the control device may comprise at least one actuator device selected from the group consisting of: an automated feeding device; an automated medication dispenser device; an automated aeration device; an automated tide gate or floodgate; an automated measuring and sorting device, such as a biomass and animal measuring and sorting device; an automated cleaning device, such as a pond or vessel cleaning device; an automated drainage device, e.g. a central drainage device; a water exchange device; an automated pump device, such as a pumping for water exchange and a pumping for water circulation rate; an automated injector device, such as injector devices for gas, water or mixtures thereof; an automated bubble creation or dosing device, such as a nanobubble or microbubble creation or dosing device; an automated harvester, such as an automated harvester for fully or partially harvesting biomass; an automated water movement device; an automated shading device, such as a shading device for fully or partially excluding sunlight; an automated device for dosing of living agents, such as for probiotics, microbiome constituents, algae, microorganisms, bacteria, viruses, phages or fungi; an automated sensor, such as a device for testing of presence, species and frequency of microbiome constituents, algae, microorganisms, bacteria, viruses, phages or fungi; an automated feeding device, such as a device for adaption of diets fed, a device for adaption of feeding inputs, e.g. from a set of feed reservoirs, a device for feeding at adapted rates, a device for feeding with adapted physical parameters for the distribution of the feed, such as radius, speed and frequency of feed dosing; an automated water parameter measuring sensor, e.g. a device for measurement of water parameters comprising one or more of pH, temperature, dissolved oxygen, salinity and redox potential; an automated water parameter adaption device, e.g. a device for measurement and adaption of water parameters comprising one or more of pH, temperature, dissolved oxygen, salinity and redox potential; an automated animal interaction device, such as a device for hiding, resting or feeding for the animals in pond or vessel.

Thus, the management demand signal may be used for performing at least one automatic process by controlling the actuator device via the control device in the absence of user interaction. Additionally or alternatively, the management demand signal may be addressed to at least one user and may suggest or recommend at least one user action.

The obtaining of the regional management parameter in step b) may comprise at least one of the following:
measuring the regional management parameter by using at least one regional management signal sensor, specifically at least one regional management signal sensor selected from the group consisting of: a regional wind sensor; a regional environmental sensor; a regional meteorological sensor; a regional tidal sensor;
determining the regional management parameter from aerial sensor data, specifically at least one of satellite data and drone data, specifically aerial sensor data selected from the group consisting of: at least one aerial parameter of use of at least one other aquaculture pond and/or at least one other aquaculture farm in the region; aerial sensor data indicative of a meteorological situation in the region; aerial sensor data indicative of flooding in the region; and
retrieving the regional management parameter from at least one electronic source, specifically from at least one electronic source selected from the group consisting of: a data base; a newsfeed, specifically a newsfeed selected from the group consisting of a meteorological newsfeed, an environmental newsfeed, a flood warning newsfeed and a disease newsfeed; the world wide web.

The term “regional management signal sensor” as used herein is a broad term and is to be given its ordinary and customary meaning to a person of ordinary skill in the art and is not to be limited to a special or customized meaning. The term specifically may refer, without limitation, to a sensor generating at least one electronic signal according to a measured variable, wherein the signal sensor is located in one of the regions regionally associated with the aquaculture farm. In particular, the regional management signal sensor may generate a measurement result. The regional management parameter may be or may comprise the measurement result.

Specifically, the regional management parameter may be selected from the group consisting of: a weather condition, specifically a presence, an absence or a duration of at least one of rainfall, hail, snow, storm, sunshine, clouds and fog; a weather-related measurand, specifically an amount of rain, hail or snow, a wind speed; a temperature; a change in temperature; a natural phenomenon, specifically a tidal level, a tide-dependent rise or fall of a water level, a wave formation, a wave height, a wave movement, a flood; a probable occurrence of a disease incidence, an actual occurrence of a disease incidence.

The method may further comprise:
g) obtaining, by the computer, at least one local sensor parameter from at least one local sensor device locally associated with the aquaculture farm.

The term “local sensor device” as used herein is a broad term and is to be given its ordinary and customary meaning to a person of ordinary skill in the art and is not to be limited to a special or customized meaning. The term specifically may refer, without limitation, to at least one electronic sensor located at the aquaculture farm or within a predefined distance range from the aquaculture farm. In particular, the local sensor device may be located within a distance of 1 km, preferably 500 m, more preferably 100 m from the farm and most preferably in or at the aquaculture farm. The term “local sensor parameter” as used herein is a broad term and is to be given its ordinary and customary meaning to a person of ordinary skill in the art and is not to be limited to a special or customized meaning. The term specifically may refer, without limitation, to a measurand, a measured quantity or a measurement value determined by the local sensor device. Specifically, the local sensor parameter may be determined within a distance of 1 km, preferably 500 m, more preferably 100 m from the farm and most preferably in or at the aquaculture farm.

The management demand signal in step c) may be determined by further taking into account the local sensor parameter. The local sensor parameter may particularly be selected from the group consisting of: water quality, preferably any of dissolved oxygen content, oxygen concentration, chemical oxygen demand, biochemical oxygen demand, temperature, salinity, chlorophyll intensity, chlorophyll concentration, turbidity, nitrogen content, nitrogen concentration, phosphorus content, phosphorus concentration; water movement, preferably any of flow volume, turbulence; pond status, preferably any of pond fill level, aeration intensity, influx volume, outflux volume; farmed animal status, preferably any of animal size, food consumption amount, food consumption frequency, mobility, pathogen pressure; environment status, preferably any of measured rainfall, measured temperature, tidal level, wind speed, sunshine duration, feed water level, feed water quality, feed water current direction and/or intensity. The local sensor device may particularly be selected from the group consisting of: a ground-based sensor device; a water-based sensor device, specifically at least one underwater sensor. The local sensor device may in particular comprise at least one of: a chemical sensor, specifically a chemical sensor for the analysis of water quality, more specifically a chemical sensor configured to detect at least one of oxygen concentration, chemical oxygen demand, biochemical oxygen demand, nitrogen concentration, phosphorus concentration and salinity; a camera, specifically a camera with at least one image sensor; a temperature sensor, a flowmeter; a rain gauge; a wind gauge; a water level indicator; a photometer; a fluorescence meter.

Step c) may further comprise determining at least one discrepancy signal using the aerial parameter of use and the regional management parameter. In particular, the discrepancy signal may comprise information regarding a difference between the aerial parameter of use and the regional management signal, specifically a difference between an actual property, quality state or condition of the aquaculture pond and/or its infrastructure and a property, quality state or condition of the aquaculture pond and/or its infrastructure that may be desirable when taking into account the regional management signal. Further, step c) may further comprise determining, by the computer, the management demand signal on the basis of the discrepancy signal.

The aerial parameter of use may be obtained, specifically derived, from at least one of the following: a color of the aquaculture pond; a reflectance of the aquaculture pond; a turbulence generated within the aquaculture pond, specifically a turbulence created by at least one aeration device within the aquaculture pond and more specifically a turbulence created by at least one paddle wheel within the aquaculture pond; air bubbles generated within the aquaculture pond, specifically air bubbles created by at least one aeration device within the aquaculture pond; a connection of the aquaculture pond to a feed water source, specifically a natural water body, specifically via at least one of water pipes, channels and reservoirs; a geographic location of the aquaculture pond, specifically a proximity to a natural water body; the presence of at least one further aquaculture pond in proximity to the aquaculture pond whose aerial parameter of use is obtained; a connection of the aquaculture pond to at least one further aquaculture pond, specifically via at least one of water pipes, channels and reservoirs. In particular, the reflectance and/or the color of the aquaculture pond may indicate whether the aquaculture pond is filled with water or whether the aquaculture pond is drained, for example due to a fallow period. Further, the turbulence within the aquaculture pond may indicate the use of an aeration device, which may typically be in use when the aquaculture pond is used for rearing aquatic organisms. In such a state the aquaculture pond may also be referred to as active. If the aquaculture pond is filled with water without being aerated, the aquaculture pond may be in a state in which it is free essentially free of aquatic organisms intended for aquaculture, e.g. in a state of preparation. Thus, the above-mentioned qualities, which may be observable or deducible from aerial sensor data, may serve as a basis for deriving the aerial parameter of use. The aerial parameter of use may in particular be selected from the group consisting of: the aquaculture pond is filled with water; the aquaculture pond is drained; the aquaculture pond is aerated, specifically by using at least one aeration device, in particular at least one of a paddle wheel, an air blowing means, a bubble-generation device, an air jet device and a water jet device; the aquaculture pond is active; the aquaculture pond is filled with water and is essentially free of aquatic organisms intended for aquaculture; the aquaculture pond uses a natural water body as feed water source, specifically at least one of a river and the ocean; the aquaculture pond is located in a predetermined geographic region, the aquaculture pond is located within a predefined distance to at least one of a natural water body and a mountain; the aquaculture pond is located within a predefined distance to at least one further aquaculture pond; the aquaculture pond shares a feed water source with at least one further aquaculture pond; the aquaculture pond has a floodgate. The aquaculture pond may also be assigned a plurality of aerial parameters of use. Thus, a current status of the aquaculture pond as indicated by its aerial parameters of use may comprise that it is active, that it is situated within a predefined distance to the sea, that it uses a nearby river as feed water source and that a further aquaculture pond belonging to an aquaculture farm located upstream of the river, also uses this river as feed water source.

Step a) may further comprise determining, by the computer, a temporal development of the aerial parameter of use on the basis of a time series of aerial parameters of use obtained by the computer. Further, the determining of the management demand signal on the basis of the aerial parameter of use and the regional management parameter may take into account the temporal development of the aerial parameter of use. Such a time series may specifically identify a sudden and/or unexpected and/or simultaneous draining of aquaculture ponds belonging to at least one aquaculture farm in one of the regions regionally associated with the aquaculture pond, on which the aquaculture farm management method of is performed. The sudden and/or unexpected and/or simultaneous draining of aquaculture ponds may indicated the occurrence of disease. The occurrence of disease in one of the regions regionally associated with the aquaculture pond, on which the aquaculture farm management method of is performed, specifically in a vicinity of said pond, may be relevant for the aquaculture pond and may influence or affect the aquaculture farm management. Thus, a feed water source may be altered, measures increasing a resilience and/or vitality of the farmed animals or plants may be taken, e.g. by increasing an oxygen supply, a change of feed, an administration of drugs, and/or measures for the killing of germs may be taken and, specifically, may be part of the management demand signal.

Further, step b) may further comprise determining, by the computer, a temporal development of the regional management parameter on the basis of a time series of regional management parameters obtained by the computer. Specifically, the determining of the management demand signal on the basis of the aerial parameter of use and the regional management parameter may take into account the temporal development of the regional management parameter. Thus, the regional management parameter may specifically be expressed or reflected in a course of measured values, specifically a time course of measured values, a measurement curve or table of measured values. Additionally or alternatively, the regional management parameter may be a single value. The single value may be a specific measurement value or it may be determined from a plurality of measurement values, specifically a time course, such as by determining a mean value.

The method may further comprise acquiring aerial sensor data, specifically at least one map or image of aerial sensor data, more specifically a sequence of aerial sensor data, wherein step a) may further comprise assigning the at least one aerial parameter of use to the aquaculture pond by using the aerial sensor data. The aerial parameter of use may specifically be assigned to the aquaculture pond by applying at least one evaluation algorithm to the aerial sensor data. The evaluation algorithm may comprise at least one image recognition algorithm, specifically for detecting one or more of: a color of the aquaculture pond; a reflectance of the aquaculture pond; a pattern within the aquaculture pond, specifically a pattern created by an aeration device; a turbulence of the aquaculture pond; a connection of the aquaculture pond to a feed water source, specifically a river or the ocean; a water supply and/or management system of the aquaculture pond, specifically water pipes, channels and reservoirs; the presence of at least one further aquaculture pond in proximity to the aquaculture pond whose aerial parameter of use is obtained; a connection of the aquaculture pond to at least one further aquaculture pond, specifically via at least one of water pipes, channels and reservoirs.

In particular, both the aerial parameter of use and the regional management parameter may comprise at least one parameter derived by remote aerial sensing, specifically by remote aerial imaging or remote aerial mapping. The remote aerial sensing may specifically comprise sensing by one or more of satellite sensing, sensing by an airplane, sensing by a drone. The remote aerial sensing may comprise one or more of: visual imaging, infrared imaging, ultraviolet imaging, radar imaging, radio imaging, ultrasound imaging. The method may further comprise identifying the at least one aquaculture pond in at least one aerial image, specifically in at least one aerial image from which the at least one aerial parameter of use is derived. The method may further comprise identifying at least one further aquaculture pond in the at least one aerial image, specifically in at least one aerial image from which the regional management parameter is derived. The aerial parameter of use and the regional management parameter may be derived from the same aerial image.

The method may specifically be carried out for a plurality of aquaculture farms simultaneously, wherein for each aquaculture farm at least one aerial parameter of use of at least one aquaculture pond may be obtained. Further, at least one common regional management parameter may be obtained for the plurality of aquaculture farms. The plurality may comprises at least 20 aquaculture farms, preferably at least 50 aquaculture farms, more preferably at least 100 aquaculture farms.

In step a) the at least one aerial parameter of use may be obtained for the at least one aquaculture pond at a predetermined frequency. The predetermined frequency, at which the at least one aerial parameter of use may be obtained, may in particular be in the range of once per hour to once per 5 days, preferably once per 2 hours to once per 3 days.

In step b) the at least one regional management parameter may be obtained at a predetermined frequency. The predetermined frequency, at which the regional management parameter may be obtained, may be in the range of once per hour to once per 5 days, preferably once per 2 hours to once per 3 days.

In particular, the aerial parameter of use and the regional management parameter may be obtained at the same predetermined frequency.

Step b) may further comprise comparing the regional management parameter with at least one reference parameter. In particular, in step c) the management demand signal may be determined depending on the comparison of the regional management parameter with the at least one reference parameter. Further, on the basis of the comparison with the at least one reference parameter, information on at least one potential risk for the aquaculture pond, whose parameter of use is obtained, may be generated. Specifically information may be generated on at least one of: a risk of flooding; a risk of salinity intrusion; a risk of storm damage; a risk of temperature change; a risk of a drop in feed water quality; a risk of disease introduction. In step c) the management demand signal may be determined in such a way as to avoid, reduce or minimize the potential risk for the aquaculture pond. The reference parameter may particularly comprise at least one of the following: a single reference parameter, a reference parameter range; a reference parameter table; at least one threshold parameter value. The reference parameter may specifically depend on at least one of the following: a location of the aquaculture pond; a season of the year.

In a further aspect, a computer program is proposed, the computer program comprising computer-executable instructions for performing the method according to one or more of the embodiments as disclosed herein when the program is executed on a computer or computer network. Specifically, the computer program may be stored on a computer-readable data carrier and/or on a computer-readable storage medium.

As used herein, the terms “computer-readable data carrier” and “computer-readable storage medium” specifically may refer to non-transitory data storage means, such as a hardware storage medium having stored thereon computer-executable instructions. The computer-readable data carrier or storage medium specifically may be or may comprise a storage medium such as a random-access memory (RAM) and/or a read-only memory (ROM).

Thus, specifically, one, more than one or even all of method steps a) to c) as indicated above or as further outlined below may be performed by using a computer or a computer network, preferably by using a computer program. Furthermore, one, more than one or even all of the optional method steps d), e), f) and g) as indicated above or as further outlined below may be performed by using a computer or a computer network, preferably by using a computer program.

In a further aspect, a computer or computer network comprising at least one processor is proposed, wherein the processor is adapted to perform the method according to one or more of the embodiments disclosed herein. Specifically, the processor may be adapted to perform more than one or even all of method steps a) to c) and optionally d), e), f) and/or g) as indicated above or as further outlined below.

In a further aspect, a computer-readable storage medium is proposed comprising instructions which, when the program is executed by a computer or computer network, cause the computer or computer network to perform the method according to one or more of the embodiments disclosed herein.

Further disclosed and proposed herein is a computer program product having program code means, in order to perform the method according to the present invention in one or more of the embodiments enclosed herein when the program is executed on a computer or computer network. Specifically, the program code means may be stored on a computer-readable data carrier and/or on a computer-readable storage medium.

Further disclosed and proposed herein is a data carrier having a data structure stored thereon, which, after loading into a computer or computer network, such as into a working memory or main memory of the computer or computer network, may execute the method according to one or more of the embodiments disclosed herein.

Further disclosed and proposed herein is a computer program product with program code means stored on a machine-readable carrier, in order to perform the method according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier and/or on a computer-readable storage medium. Specifically, the computer program product may be distributed over a data network.

Further, disclosed and proposed herein is a modulated data signal, which contains instructions readable by a computer system or computer network, for performing the method according to one or more of the embodiments disclosed herein.

Referring to the computer-implemented aspects of the invention, one or more of the method steps, specifically steps a), b) and c) of the method, or even all of the method steps of the method according to one or more of the embodiments disclosed herein may be performed by using a computer or computer network. Thus, generally, any of the method steps including pro-vision and/or manipulation of data may be performed by using a computer or computer network. Generally, these method steps may include any of the method steps, typically except for method steps requiring manual work, such as certain aspects of performing an actual measurement.

In a further aspect, an aquaculture farm management system for managing at least one aquaculture farm having at least one aquaculture pond is proposed. The aquaculture farm management system comprises at least one computer configured for obtaining at least one aerial parameter of use of at least one aquaculture pond of at least one aquaculture farm, wherein the computer is further configured for obtaining at least one regional management parameter of at least one region regionally associated with the aquaculture farm, wherein the computer, specifically at least one processor of the computer, is furthermore configured for determining at least one management demand signal for the aquaculture pond on the basis of the aerial parameter of use and the regional management parameter.

Regarding terms and definitions in relation with the aquaculture farm management system, reference may be made to the terms and definitions as given in relation to the aquaculture farm management method as described above or as further described below. The aquaculture farm management system may specifically be configured for at least partially performing the aquaculture farm management method as described above or as further described below. Thus, the aquaculture farm management system may specifically be configured for performing more than one or even all of method steps a) to c) and optionally d), e), f) and/or g) of the aquaculture farm management method as indicated above or as further outlined below.

The term “system” as used herein is a broad term and is to be given its ordinary and customary meaning to a person of ordinary skill in the art and is not to be limited to a special or customized meaning. The term specifically may refer, without limitation, to a set of interacting or interde-pendent components and/or parts forming a whole or to an element comprising a plurality of interacting components or interacting functional units. Specifically, the components or functional units may interact with each other in order to fulfill at least one common function or to solve at least one common task. Thus, the aquaculture farm management system may refer to a system configured for determining the management demand signal for the aquaculture pond on the basis of the aerial parameter of use and the regional management parameter. Specifically, the computer of the aquaculture farm management system may comprise a plurality of components or functional units, which may interact to determine the management demand signal. The components may specifically comprise the processor, which may be configured for determining the management demand signal. The computer is furthermore configured for obtaining the aerial parameter of use of the aquaculture pond and for obtaining the regional management parameter of the region regionally associated with the aquaculture farm. Specifically the processor may be configured for determining one or both of the aerial parameter of use and the regional management signal. Additionally or alternatively, the computer may obtain one or both of the aerial parameter of use and the regional management parameter by receiving the one or both of the aerial parameter of use and the regional management parameter, such as from a further electronic device, specifically a computer, e.g. via at least one interface.

The term “processor” as used herein is a broad term and is to be given its ordinary and customary meaning to a person of ordinary skill in the art and is not to be limited to a special or customized meaning. The term specifically may refer, without limitation, to an arbitrary logic circuitry configured for performing basic operations of a computer or system, and/or, generally, to a device which is configured for performing calculations or logic operations. In particular, the processor may be configured for processing basic instructions that drive the computer or system. As an example, the processor may comprise at least one arithmetic logic unit (ALU), at least one floating-point unit (FPU), such as a math co-processor or a numeric co-processor, a plurality of registers, specifically registers configured for supplying operands to the ALU and storing results of operations, and a memory, such as an L1 and L2 cache memory. In particular, the processor may be a multi-core processor. Specifically, the processor may be or may comprise a central processing unit (CPU). Additionally or alternatively, the processor may be or may comprise a microprocessor, thus specifically the processor's elements may be contained in one single integrated circuitry (IC) chip. Additionally or alternatively, the processor may be or may comprise one or more application-specific integrated circuits (ASICs) and/or one or more field-programmable gate arrays (FPGAs) and/or one or more tensor processing unit (TPU) and/or one or more chip, such as a dedicated machine learning optimized chip, or the like. The processor specifically may be configured, such as by software programming, for performing one or more evaluation operations.

The aquaculture farm management system may further comprise at least one transmitter for transmitting the management demand signal to at least one predefined location remote from the computer, specifically to a location close to the aquaculture pond whose aerial parameter of use is obtained. Different ways and methods of transmission, specifically wireless transmission, are feasible.

The aquaculture farm management system may further comprise at least one control device, specifically at least one control device of the aquaculture farm, configured for retrieving the management demand signal. Specifically, the transmitter may be configured for providing the management demand signal to the control device. Data transfer between the transmitter and the control device may take place via numerous ways, specifically via wireless data transfer e.g. using radio waves, such as Wi-Fi, LTE, LTE-advanced or Bluetooth. The use of a physical connection for data transfer is also feasible. The control device may be configured for being controlled according to the management demand signal in an automated fashion, e.g. automatically. The control device may further comprise at least one display configured for displaying the management demand signal. In particular, the control device may comprise at least one user device configured for informing the user about the management demand signal. Specifically, the user device may comprise the display. Further, the user device may inform the user about the management demand signal via the display. Additionally or alternatively, the user device may comprise an augmented reality element, e.g. a virtual reality headset, configured to instruct the user to perform at least one action according to the management demand signal.

The control device may further comprise at least one actuator device. In particular, the control device may comprise at least one actuator device selected from the group consisting of: an automated feeding device; an automated medication dispenser device; an automated aeration device; an automated tide gate or floodgate; an automated measuring and sorting device, such as a biomass and animal measuring and sorting device; an automated cleaning device, such as a pond or vessel cleaning device; an automated drainage device, e.g. a central drainage device; a water exchange device; an automated pump device, such as a pumping for water exchange and a pumping for water circulation rate; an automated injector device, such as injector devices for gas, water or mixtures thereof; an automated bubble creation or dosing device, such as a nanobubble or microbubble creation or dosing device; an automated harvester, such as an automated harvester for fully or partially harvesting biomass; an automated water movement device; an automated shading device, such as a shading device for fully or partially excluding sunlight; an automated device for dosing of living agents, such as for probiotics, microbiome constituents, algae, microorganisms, bacteria, viruses, phages or fungi; an automated sensor, such as a device for testing of presence, species and frequency of microbiome constituents, algae, microorganisms, bacteria, viruses, phages or fungi; an automated feeding device, such as a device for adaption of diets fed, a device for adaption of feeding inputs, e.g. from a set of feed reservoirs, a device for feeding at adapted rates, a device for feeding with adapted physical parameters for the distribution of the feed, such as radius, speed and frequency of feed dosing; an automated water parameter measuring sensor, e.g. a device for measurement of water parameters comprising one or more of pH, temperature, dissolved oxygen, salinity and redox potential; an automated water parameter adaption device, e.g. a device for measurement and adaption of water parameters comprising one or more of pH, temperature, dissolved oxygen, salinity and redox potential; an automated animal interaction device, such as a device for hiding, resting or feeding for the animals in pond or vessel.

The aquaculture farm management system may further comprise at least one local sensor locally associated with the aquaculture farm configured for determining at least one local sensor parameter. The computer of the aquaculture farm management system may comprise at least one interface for one or both of obtaining the at least one aerial parameter of use of the aquaculture pond and obtaining data from which the at least one aerial parameter of use of the aquaculture pond is derivable. The term “interface” as used herein is a broad term and is to be given its ordinary and customary meaning to a person of ordinary skill in the art and is not to be limited to a special or customized meaning. The term specifically may refer, without limitation, to an item or element forming a boundary configured for transferring information. In particular, the interface may be configured for transferring information onto a computational device, e.g. onto a computer, such as to receive information. Additionally or alternatively, the interface may be configured for transferring information from a computational device, e.g. a computer, such as to send or output information, e.g. onto another device. The interface may specifically provide means for transferring or exchanging information. In particular, the interface may provide a data transfer connection, e.g. Bluetooth, NFC, inductive coupling or the like. As an example, the interface may be or may comprise at least one port comprising one or more of a network or internet port, a USB-port and a disk drive. The interface may further comprise at least one display. The interface may be at least one web interface. The interface may further be configured for one or both of obtaining the at least one regional management parameter or obtaining data from which the at least one regional management parameter is derivable. The interface may further be configured for receiving aerial sensor data, specifically at least one map or image of aerial sensor data, more specifically a sequence of aerial sensor data, wherein the interface may further be configured for assigning the at least one aerial parameter of use to the aquaculture pond by using the aerial sensor data. The interface may further be configured for deriving the regional management parameter from the aerial sensor data.

The aquaculture farm management system comprises at least one computer. The computer, specifically the processor of the computer, may be configured for assigning the aerial parameter of use to the aquaculture pond by applying at least one evaluation algorithm to the aerial sensor data. The computer may further be configured for receiving and/or processing of the aerial sensor data, specifically remote aerial sensor data, more specifically remote aerial imaging data or remote aerial mapping data. The computer may further be configured for assigning the aerial parameter of use to the aquaculture pond by applying at least one evaluation algorithm to the aerial sensor data. The computer may further be configured for receiving and/or processing of the aerial sensor data, specifically remote aerial sensor data, more specifically remote aerial imaging data or remote aerial mapping data. The computer may furthermore be configured for identifying the at least one aquaculture pond in at least one aerial image, specifically at least one aerial image from which the at least one aerial parameter of use is derived. The computer may be configured for comparing the regional management parameter with at least one reference parameter.

The aquaculture farm management system may comprise at least one database comprising the at least one reference parameter. Specifically, the computer may be configured for generating information on at least one potential risk for the aquaculture pond, whose parameter of use is obtained, on the basis of the comparison with the reference parameter.

The aquaculture farm management system may comprise a storage element. The storage element may specifically be configured for storing at least one data element, such as at least one piece of data in electronic form. In particular, at least one of the following may be stored on the storage element: the at least one aerial parameter of use; the at least one regional management parameter; the at least one management demand signal; a time course of the aerial parameter of use; a time course of the regional management parameter; a time course of the management demand signal; the aerial sensor data; the reference parameter.

The proposed methods and devices, specifically the computer-implemented aquaculture farm management method and the aquaculture farm management system, have numerous advantages over comparable methods and devices known in the art. In particular, the aquaculture farm management method and the aquaculture farm management system may gather, process and provide information relevant for the aquaculture farm management. In particular, such information may concern and/or take into account external influences, which for an individual farmer may be difficult or even impossible to control or to foresee. Nevertheless, such external influences, which may originate or become visible only and/or in time to take measures at loca-tions separate and/or distant from the aquaculture farm, may require timely actions to avoid or reduce negative effects or the risks of negative effects. Such negative effects may include conditions that are detrimental or even lethal to the farmed animals and/or plants. The proposed aquaculture farm management method and the aquaculture farm management system may facilitate taking such timely actions that may protect the farming effort, in particular the farmed species, of one or several ponds of the aquaculture farm by providing relevant information and/or instructions in a timely manner. Further, the proposed methods and devices, specifically the computer-implemented aquaculture farm management method and the aquaculture farm management system, may be applicable easily and cost-efficiently in particular to aquaculture farms with one or several aquaculture ponds situated in the open air.

Summarizing and without excluding further possible embodiments, the following embodiments may be envisaged:

Embodiment 1: A computer-implemented aquaculture farm management method, comprising
a) obtaining, by at least one computer, at least one aerial parameter of use of at least one aquaculture pond of at least one aquaculture farm;
b) obtaining, by the computer, at least one regional management parameter of at least one region regionally associated with the aquaculture farm; and
c) determining, by the computer, at least one management demand signal for the aquaculture pond on the basis of the aerial parameter of use and the regional management parameter.

Embodiment 2: The method according to the preceding embodiment, wherein the management demand signal comprises control information on at least one of the following aquaculture pond management actions: an adjustment of feed composition; an adjustment of feed amount; an adjustment of feed timing; an adjustment of medication dispensation; an adjustment of aeration; an adjustment of filtration; an adjustment of salinity; an adjustment of water flow; an adjustment of influx volume; an adjustment of outflux volume; an adjustment of timing of animal release into the aquaculture pond; an adjustment of harvest time, specifically a harvesting of the aquaculture pond at a predetermined time or in a predetermined time range; an adjustment of a status of at least one tide gate or floodgate, specifically a closure or an opening of the tide gate or floodgate; an adjustment of a feed water source, specifically a change of a feed water source from a natural water body like a river to a reservoir or vice versa; a use or removal of at least one protection device, specifically at least one covering device.

Embodiment 3: The method according to any one of the preceding embodiments, further comprising
d) providing, to at least one control device, specifically at least one control device of the aquaculture farm, the management demand signal.

Embodiment 4: The method according to the preceding embodiment, further comprising
e) automatically controlling the control device according to the management demand signal.

Embodiment 5: The method according to any one of the two preceding embodiments, further comprising
f) informing a user, by at least one user device of the control device, about the management demand signal.

Embodiment 6: The method according to the preceding embodiment, wherein in step f) the user is informed about the management demand signal by displaying the management demand signal by at least one display of the user device, e.g. of the control device.

Embodiment 7: The method according to any one of the two preceding embodiments, wherein step f) further comprises instructing the user for performing at least one action according to the management demand signal.

Embodiment 8: The method according to the preceding embodiment, wherein in step f) the user is instructed to perform the at least one action by providing guidance to the user by an augmented reality element of the user device, such as by a virtual reality headset, e.g. by superimposing guidance information in a field of view of the user.

Embodiment 9: The method according to any one of the six preceding embodiments, wherein the control device comprises at least one actuator device selected from the group consisting of: an automated feeding device; an automated medication dispenser device; an automated aeration device; an automated tide gate or floodgate; an automated measuring and sorting device, such as a biomass and animal measuring and sorting device; an automated cleaning device, such as a pond or vessel cleaning device; an automated drainage device, e.g. a central drainage device; a water exchange device; an automated pump device, such as a pumping for water exchange and a pumping for water circulation rate, an automated injector device, such as injector devices for gas, water or mixtures thereof; an automated bubble creation or dosing device, such as a nanobubble or microbubble creation or dosing device; an automated harvester, such as an automated harvester for fully or partially harvesting biomass; an automated water movement device; an automated shading device, such as a shading device for fully or partially excluding sunlight; an automated device for dosing of living agents, such for probiotics, microbiome constituents, algae, microorganisms, bacteria, viruses, phages or fungi; an automated sensor, such as a device for testing of presence, species and frequency of microbiome constituents, algae, microorganisms, bacteria, viruses, phages or fungi; an automated feeding device, such as a device for adaption of diets fed, a device for adaption of feeding inputs, e.g. from a set of feed reservoirs, a device for feeding at adapted rates, a device for feeding with adapted physical parameters for the distribution of the feed, such as radius, speed and frequency of feed dosing; an automated water parameter measuring sensor, e.g. a device for measurement of water parameters comprising one or more of pH, temperature, dissolved oxygen, salinity and redox potential; an automated water parameter adaption device, e.g. a device for measurement and adaption of water parameters comprising one or more of pH, temperature, dissolved oxygen, salinity and redox potential; an automated animal interaction device, such as a device for hiding, resting or feeding for the animals in pond or vessel.

Embodiment 10: The method according to any one of the preceding embodiments, wherein the obtaining of the regional management parameter in step b) comprises at least one of the following:
measuring the regional management parameter by using at least one regional management signal sensor, specifically at least one regional management signal sensor selected from the group consisting of: a regional wind sensor; a regional environmental sensor; a regional meteorological sensor; a regional tidal sensor;
determining the regional management parameter from aerial sensor data, specifically at least one of satellite data and drone data, specifically aerial sensor data selected from the group consisting of: at least one aerial parameter of use of at least one other aquaculture pond and/or at least one other aquaculture farm in the region; aerial sensor data indicative of a meteorological situation in the region; aerial sensor data indicative of flooding in the region;
retrieving the regional management parameter from at least one electronic source, specifically from at least one electronic source selected from the group consisting of: a data base; a newsfeed, specifically a newsfeed selected from the group consisting of a meteorological newsfeed, an environmental newsfeed, a flood warning newsfeed and a disease newsfeed; the world wide web.

Embodiment 11: The method according to any one of the preceding embodiments, the method further comprising
g) obtaining, by the computer, at least one local sensor parameter from at least one local sensor device locally associated with the aquaculture farm.

Embodiment 12: The method according to the preceding embodiment, wherein the management demand signal in step c) is determined by further taking into account the local sensor parameter.

Embodiment 13: The method according to any one of the two preceding embodiments, wherein the local sensor parameter is selected from the group consisting of: water quality, preferably any of dissolved oxygen content, oxygen concentration, chemical oxygen demand, biochemical oxygen demand, temperature, salinity, chlorophyll intensity, chlorophyll concentration, turbidity, nitrogen content, nitrogen concentration, phosphorus content, phosphorus concentration; water movement, preferably any of flow volume, turbulence; pond status, preferably any of pond fill level, aeration intensity, influx volume, outflux volume; farmed animal status, preferably any of animal size, food consumption amount, food consumption frequency, mobility, pathogen pressure; environment status, preferably any of measured rainfall, measured temperature, tidal level, wind speed, sunshine duration, feed water level, feed water quality, feed water current direction and/or intensity.

Embodiment 14: The method according to any one of the three preceding embodiments, wherein the local sensor device is selected from the group consisting of: a ground-based sensor device; a water-based sensor device, specifically at least one underwater sensor.

Embodiment 15: The method according to any one of the four preceding embodiments, wherein the local sensor device comprises at least one of: a chemical sensor, specifically a chemical sensor for the analysis of water quality, more specifically a chemical sensor configured to detect at least one of oxygen concentration, chemical oxygen demand, biochemical oxygen demand, nitrogen concentration, phosphorus concentration and salinity; a camera, specifically a camera with at least one image sensor; a temperature sensor, a flowmeter; a rain gauge; a wind gauge; a water level indicator; a photometer; a fluorescence meter.

Embodiment 16: The method according to any one of the five preceding embodiments, wherein the local sensor parameter is determined within a distance of 1 km, preferably 500 m, more preferably 100 m and most preferably in or at the aquaculture farm.

Embodiment 17: The method according to any one of the preceding embodiments, wherein step c) further comprises determining at least one discrepancy signal using the aerial parameter of use and the regional management parameter.

Embodiment 18: The method according to the preceding embodiment, wherein step c) further comprises determining, by the computer, the management demand signal on the basis of the discrepancy signal.

Embodiment 19: The method according to any one of the preceding embodiments, wherein the aerial parameter of use is obtained, specifically derived, from at least one of the following: a color of the aquaculture pond; a reflectance of the aquaculture pond; a turbulence generated within the aquaculture pond, specifically a turbulence created by at least one aeration device within the aquaculture pond and more specifically a turbulence created by at least one paddle wheel within the aquaculture pond; air bubbles generated within the aquaculture pond, specifically air bubbles created by at least one aeration device within the aquaculture pond; a connection of the aquaculture pond to a feed water source, specifically a natural water body, specifically via at least one of water pipes, channels and reservoirs; a geographic location of the aquaculture pond, specifically a proximity to a natural water body; the presence of at least one further aquaculture pond in proximity to the aquaculture pond whose aerial parameter of use is obtained; a connection of the aquaculture pond to at least one further aquaculture pond, specifically via at least one of water pipes, channels and reservoirs.

Embodiment 20: The method according to any one of the preceding embodiments, wherein the aerial parameter of use is selected from the group consisting of: the aquaculture pond is filled with water; the aquaculture pond is drained; the aquaculture pond is aerated, specifically by using at least one aeration device, in particular at least one of a paddle wheel, an air blowing means, a bubble-generation device, an air jet device and a water jet device; the aquaculture pond is active; the aquaculture pond is filled with water and is essentially free of aquatic organisms intended for aquaculture; the aquaculture pond uses a natural water body as feed water source, specifically at least one of a river and the ocean; the aquaculture pond is located in a predetermined geographic region, the aquaculture pond is located within a predefined distance to at least one of a natural water body and a mountain; the aquaculture pond is located within a predefined distance to at least one further aquaculture pond; the aquaculture pond shares a feed water source with at least one further aquaculture pond.

Embodiment 21: The method according to any one of the preceding embodiments, wherein the aquaculture pond is assigned a plurality of aerial parameters of use.

Embodiment 22: The method according to any one of the preceding embodiments, wherein the regional management parameter is selected from the group consisting of: a weather condition, specifically a presence, an absence or a duration of at least one of rainfall, hail, snow, storm, sunshine, clouds and fog; a weather-related measurand, specifically an amount of rain, hail or snow, a wind speed; a temperature; a change in temperature; a natural phenomenon, specifically a tidal level, a tide-dependent rise or fall of a water level, a wave formation, a wave height, a wave movement, a flood; a probable occurrence of a disease incidence, an actual occurrence of a disease incidence.

Embodiment 23: The method according to any one of the preceding embodiments, wherein step a) further comprises determining, by the computer, a temporal development of the aerial parameter of use on the basis of a time series of aerial parameters of use obtained by the computer.

Embodiment 24: The method according to the preceding embodiment, wherein the determining of the management demand signal on the basis of the aerial parameter of use and the regional management parameter takes into account the temporal development of the aerial parameter of use.

Embodiment 25: The method according to any one of the preceding embodiments, wherein step b) further comprises determining, by the computer, a temporal development of the regional management parameter on the basis of a time series of regional management parameters obtained by the computer.

Embodiment 26: The method according to the preceding embodiment, wherein the determining of the management demand signal on the basis of the aerial parameter of use and the regional management parameter takes into account the temporal development of the regional management parameter.

Embodiment 27: The method according to any one of the preceding embodiments, wherein the method further comprises acquiring aerial sensor data, specifically at least one map or image of aerial sensor data, more specifically a sequence of aerial sensor data, wherein step a) further comprises assigning the at least one aerial parameter of use to the aquaculture pond by using the aerial sensor data.

Embodiment 28: The method according to the preceding embodiment, wherein the aerial parameter of use is assigned to the aquaculture pond by applying at least one evaluation algorithm to the aerial sensor data.

Embodiment 29: The method according to the preceding embodiment, wherein the evaluation algorithm comprises at least one image recognition algorithm, specifically for detecting one or more of: a color of the aquaculture pond; a reflectance of the aquaculture pond; a pattern within the aquaculture pond, specifically a pattern created by an aeration device; a turbulence of the aquaculture pond; a connection of the aquaculture pond to a feed water source, specifically a river or the ocean; a water supply and/or management system of the aquaculture pond, specifically water pipes, channels and reservoirs; the presence of at least one further aquaculture pond in proximity to the aquaculture pond whose aerial parameter of use is obtained; a connection of the aquaculture pond to at least one further aquaculture pond, specifically via at least one of water pipes, channels and reservoirs.

Embodiment 30: The method according to any one of the preceding embodiments, wherein both the aerial parameter of use and the regional management parameter comprise at least one parameter derived by remote aerial sensing, specifically by remote aerial imaging or remote aerial mapping.

Embodiment 31: The method according to the preceding embodiment, wherein the remote aerial sensing comprises sensing by one or more of satellite sensing, sensing by an airplane, sensing by a drone.

Embodiment 32: The method according to any one of the two preceding embodiments, wherein the remote aerial sensing comprises one or more of: visual imaging, infrared imaging, ultraviolet imaging, radar imaging, radio imaging, ultrasound imaging.

Embodiment 33: The method according to any one of the preceding embodiments, wherein the method further comprises identifying the at least one aquaculture pond in at least one aerial image, specifically in at least one aerial image from which the at least one aerial parameter of use is derived.

Embodiment 34: The method according to the preceding embodiment, wherein the method further comprises identifying at least one further aquaculture pond in the at least one aerial image, specifically in at least one aerial image from which the regional management parameter is derived.

Embodiment 35: The method according to any one of the two preceding embodiments, wherein the aerial parameter of use and the regional management parameter are derived from the same aerial image.

Embodiment 36: The method according to any one of the preceding embodiments, wherein the method is carried out for a plurality of aquaculture farms simultaneously, wherein for each aquaculture farm at least one aerial parameter of use of at least one aquaculture pond is obtained.

Embodiment 37: The method according to the preceding embodiment, wherein at least one common regional management parameter is obtained for the plurality of aquaculture farms.

Embodiment 38: The method according to any one of the two preceding embodiments, wherein the plurality comprises at least 20 aquaculture farms, preferably at least 50 aquaculture farms, more preferably at least 100 aquaculture farms.

Embodiment 39: The method according to any one of the preceding embodiments, wherein in step a) the at least one aerial parameter of use is obtained for the at least one aquaculture pond at a predetermined frequency.

Embodiment 40: The method according to the preceding embodiment, wherein the predetermined frequency at which the at least one aerial parameter of use is obtained is in the range of once per hour to once per 5 days, preferably once per 2 hours to once per 3 days.

Embodiment 41: The method according to any one of the preceding embodiments, wherein in step b) the at least one regional management parameter is obtained at a predetermined frequency.

Embodiment 42: The method according to the preceding embodiment, wherein the predetermined frequency at which the regional management parameter is obtained is in the range of once per hour to once per 5 days, preferably once per 2 hours to once per 3 days.

Embodiment 43: The method according to any one of the four preceding embodiments, wherein the aerial parameter of use and the regional management parameter are obtained at the same predetermined frequency.

Embodiment 44: The method according to any one of the preceding embodiments, wherein the aquaculture pond is used for growing one or more of shellfish or crustaceans, preferably shrimp and/or prawn.

Embodiment 45: The method according to any one of the preceding embodiments, wherein step b) further comprises comparing the regional management parameter with at least one reference parameter.

Embodiment 46: The method according to the preceding embodiment, wherein in step c) the management demand signal is determined depending on the comparison of the regional management parameter with the at least one reference parameter.

Embodiment 47: The method according to any one of the two preceding embodiment, wherein on the basis of the comparison with the at least one reference parameter, information on at least one potential risk for the aquaculture pond, whose parameter of use is obtained, is generated, specifically information on at least one of: a risk of flooding; a risk of salinity intrusion; a risk of storm damage; a risk of temperature change; a risk of a drop in feed water quality; a risk of disease introduction.

Embodiment 48: The method according to the preceding embodiment, wherein in step c) the management demand signal is determined in such a way as to avoid, reduce or minimize the potential risk for the aquaculture pond.

Embodiment 49: The method according to any one of the four preceding embodiments, wherein the reference parameter comprises at least one of the following: a single reference parameter, a reference parameter range; a reference parameter table; at least one threshold parameter value.

Embodiment 50: The method according to any one of the five preceding embodiments, wherein the reference parameter depends on at least one of the following: a location of the aquaculture pond; a season of the year.

Embodiment 51: A computer program comprising computer-executable instructions for performing the method according to any one of the preceding embodiments when the program is executed on a computer or computer network.

Embodiment 52: A computer or computer network comprising at least one processor, wherein the processor is adapted to perform the method according to any one of the preceding method embodiments.

Embodiment 53: A computer-readable storage medium comprising instructions which, when the program is executed by a computer or computer network, cause the computer or computer network to perform the method according to any one of the preceding method embodiments.

Embodiment 54: An aquaculture farm management system for managing at least one aquaculture farm having at least one aquaculture pond, the system comprising at least one computer configured for obtaining at least one aerial parameter of use of at least one aquaculture pond of at least one aquaculture farm, wherein the computer is further configured for obtaining at least one regional management parameter of at least one region regionally associated with the aquaculture farm, wherein the computer, specifically at least one processor of the computer, is furthermore configured for determining at least one management demand signal for the aquaculture pond on the basis of the aerial parameter of use and the regional management parameter.

Embodiment 55: The aquaculture farm management system according to the preceding embodiment, wherein the aquaculture farm management system is configured for performing the aquaculture farm management method according to any one of the preceding embodiments referring to an aquaculture farm management method.

Embodiment 56: The aquaculture farm management system according to any one of the preceding embodiments referring to an aquaculture farm management system, wherein the aquaculture farm management system further comprises at least one transmitter for transmitting the management demand signal to at least one predefined location remote from the computer, specifically to a location close to the aquaculture pond whose aerial parameter of use is obtained.

Embodiment 57: The aquaculture farm management system according to any one of the preceding embodiments referring to an aquaculture farm management system, wherein the aquaculture farm management system further comprises at least one control device, specifically at least one control device of the aquaculture farm, configured for retrieving the management demand signal.

Embodiment 58: The aquaculture farm management system according to the preceding embodiment, wherein the control device is configured for being controlled according to the management demand signal in an automated fashion.

Embodiment 59: The aquaculture farm management system according to any one of the two preceding embodiments, wherein the control device further comprises at least one display configured for displaying the management demand signal.

Embodiment 60: The aquaculture farm management system according to any one of the three preceding embodiments, wherein the control device further comprises at least one actuator device selected from the group consisting of: an automated feeding device; an automated medication dispenser device; an automated aeration device; an automated tide gate or floodgate; an automated measuring and sorting device, such as a biomass and animal measuring and sorting device; an automated cleaning device, such as a pond or vessel cleaning device; an automated drainage device, e.g. a central drainage device; a water exchange device; an automated pump device, such as a pumping for water exchange and a pumping for water circulation rate, an automated injector device, such as injector devices for gas, water or mixtures thereof; an automated bubble creation or dosing device, such as a nanobubble or microbubble creation or dosing device; an automated harvester, such as an automated harvester for fully or partially harvesting biomass; an automated water movement device; an automated shading device, such as a shading device for fully or partially excluding sunlight; an automated device for dosing of living agents, such for probiotics, microbiome constituents, algae, microorganisms, bacteria, viruses, phages or fungi; an automated sensor, such as a device for testing of presence, species and frequency of microbiome constituents, algae, microorganisms, bacteria, viruses, phages or fungi; an automated feeding device, such as a device for adaption of diets fed, a device for adaption of feeding inputs, e.g. from a set of feed reservoirs, a device for feeding at adapted rates, a device for feeding with adapted physical parameters for the distribution of the feed, such as radius, speed and frequency of feed dosing; an automated water parameter measuring sensor, e.g. a device for measurement of water parameters comprising one or more of pH, temperature, dissolved oxygen, salinity and redox potential; an automated water parameter adaption device, e.g. a device for measurement and adaption of water parameters comprising one or more of pH, temperature, dissolved oxygen, salinity and redox potential; an automated animal interaction device, such as a device for hiding, resting or feeding for the animals in pond or vessel.

Embodiment 61: The aquaculture farm management system according to any one of the preceding embodiments referring to an aquaculture farm management system, wherein the aquaculture farm management system further comprises at least one local sensor locally associated with the aquaculture farm configured for determining at least one local sensor parameter.

Embodiment 62: The aquaculture farm management system according to any one of the preceding embodiments referring to an aquaculture farm management system, wherein the computer comprises at least one interface for one or both of obtaining the at least one aerial parameter of use of the aquaculture pond and obtaining data from which the at least one aerial parameter of use of the aquaculture pond is derivable.

Embodiment 63: The aquaculture farm management system according to the preceding embodiment, wherein the interface is further configured for one or both of obtaining the at least one regional management parameter or obtaining data from which the at least one regional management parameter is derivable.

Embodiment 64: The aquaculture farm management system according to any one of the two preceding embodiments, wherein the interface is configured for receiving aerial sensor data, specifically at least one map or image of aerial sensor data, more specifically a sequence of aerial sensor data, wherein the interface is further configured for assigning the at least one aerial parameter of use to the aquaculture pond by using the aerial sensor data.

Embodiment 65: The aquaculture farm management system according to the preceding embodiment, wherein the interface is further configured for deriving the regional management parameter from the aerial sensor data.

Embodiment 66: The aquaculture farm management system according to any one of the two preceding embodiments, wherein the computer is further configured for assigning the aerial parameter of use to the aquaculture pond by applying at least one evaluation algorithm to the aerial sensor data.

Embodiment 67: The aquaculture farm management system according to any one of the four preceding embodiments, wherein the computer is further configured for receiving and/or processing of the aerial sensor data, specifically remote aerial sensor data, more specifically remote aerial imaging data or remote aerial mapping data.

Embodiment 68: The aquaculture farm management system according to any one of the preceding embodiments referring to an aquaculture farm management system, wherein the computer is further configured for identifying the at least one aquaculture pond in at least one aerial image, specifically at least one aerial image from which the at least one aerial parameter of use is derived.

Embodiment 69: The aquaculture farm management system according to any one of the preceding embodiments referring to an aquaculture farm management system, wherein the computer is further configured for comparing the regional management parameter with at least one reference parameter.

Embodiment 70: The aquaculture farm management system according to the preceding embodiment, wherein the aquaculture farm management system further comprises at least one database comprising the at least one reference parameter.

Embodiment 71: The aquaculture farm management system according to any one of the two preceding embodiments, wherein the computer is further configured for generating information on at least one potential risk for the aquaculture pond, whose parameter of use is obtained, on the basis of the comparison with the reference parameter.

Embodiment 72: The aquaculture farm management system according to any one of the preceding embodiments referring to an aquaculture farm management system, wherein the aquaculture farm management system further comprises a storage element.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIGS. 1A and 1B show flow charts of different embodiments of a computer-implemented aquaculture farm management method; and

FIGS. 2A and 2B show schematic views of different embodiments of an aquaculture farm management system.

In the following, these figures will be described in a combined fashion

### DETAILED DESCRIPTION OF THE EMBODIMENTS

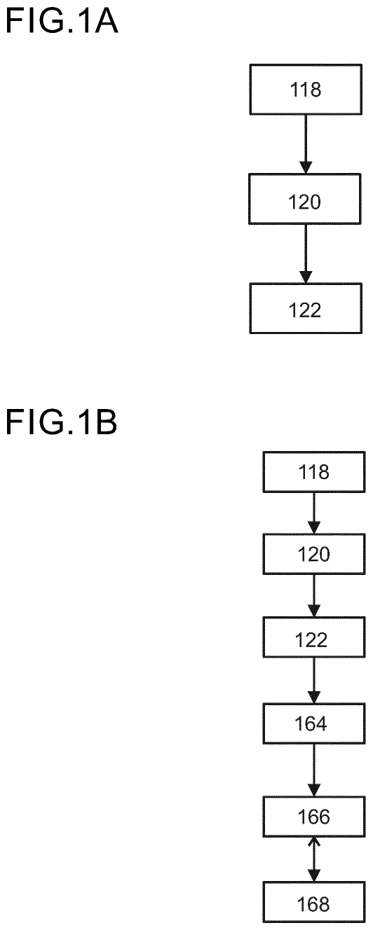

FIG. 1A illustrates with a flow chart an embodiment of a computer-implemented aquaculture farm management method. The method comprises the following steps, preferably in the indicated order. A different order, however, may be possible. Further, one or several or all steps may be performed once or repeatedly. Furthermore, two or several or all of the steps may be performed successively or in a fully or partially temporally overlapping fashion. The method may in addition to the indicated steps comprise further steps. The method steps are the following:
a) obtaining, by at least one computer 110, at least one aerial parameter of use of at least one aquaculture pond 112 of at least one aquaculture farm 114;
b) obtaining, by the computer 110, at least one regional management parameter of at least one region 116 regionally associated with the aquaculture farm 114; and
c) determining, by the computer 110, at least one management demand signal for the aquaculture pond 112 on the basis of the aerial parameter of use and the regional management parameter.

In the flow chart of FIG. 1A step a) is represented by reference sign 118, step b) is represented by reference sign 120 and step c) is represented by reference sign 122.

The proposed aquaculture farm management method is computer-implemented. The computer 110 may comprise at least one processor 124, which is configured for performing at least one of the method steps. Specifically, each of the method steps, in particular method steps a), b) and c), may be performed by the computer 110. In particular, the processor 124 may be configured for performing each of the method steps, specifically method steps a), b) and c). The method may be performed completely automatically, specifically without user interaction.

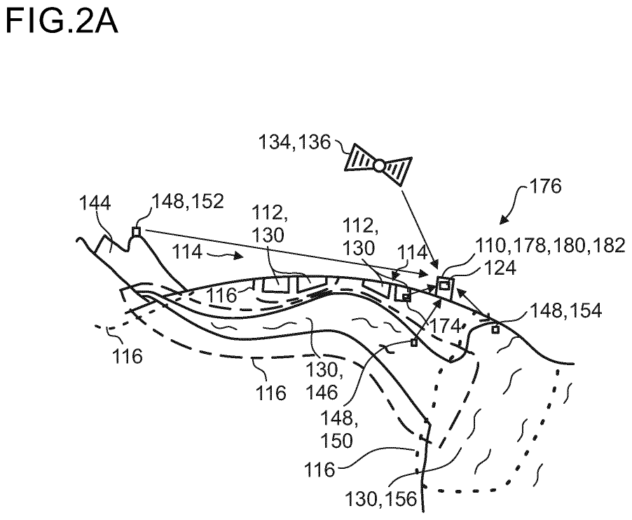

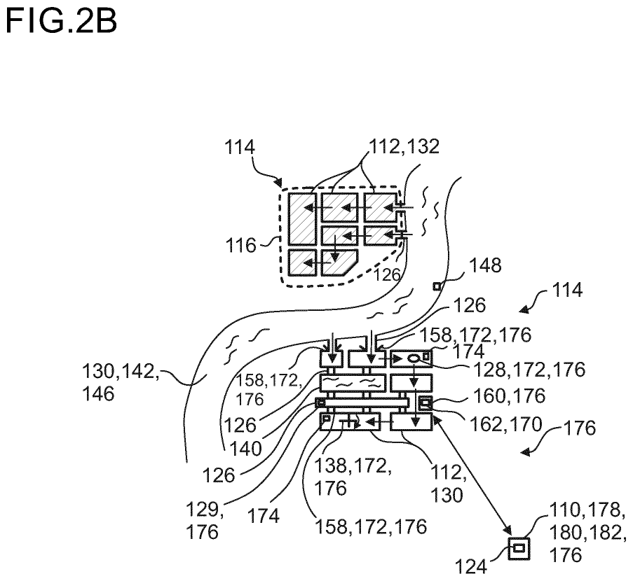

The aquaculture farm 114 may comprise one or several aquaculture ponds 112, such as 2, 5, 10 or even more aquaculture ponds 112 as shown in FIGS. 2 and 3. The aquaculture farm 114 may comprise further areas surrounding or bordering on the at least one aquaculture pond 112 and/or areas situated between the aquaculture ponds 112 of the aquaculture farm 114. Such areas may be used for maintenance purposes. In particular, they may comprise infrastructure in connection with the aquaculture farming such as channels 126, pipes, pumps 129, reservoirs 140, floodgates 158 or other means of water management; feeding devices 128; fences or other security means; sensor devices. In particular, the at least one aquaculture pond 112 and the further areas may together form a coherent area of the aquaculture farm 114. FIG. 2B illustrates an aquaculture farm 114, a direction of water flowing along channels 126 and pipes (not shown) being indicated by arrows. The depicted aquaculture farm 114 comprises several channels 126 connecting the aquaculture ponds 112 with the river 147 and/or the reservoir 140 as well as a pump 129 for a distribution of feed water. The channels 126 may be openable and closable by floodgates 158. As shown in FIG. 2B, some of the floodgates 158 may be open, while some floodgates 158 may be closed such that a feed water source 142 may be chosen, e.g. the river 146 as depicted in FIG. 2B. Additionally or alternatively, the reservoir 140 may be chosen as feed water source 142.

The aquaculture pond may comprise a waterbody 130, in particular an artificial waterbody. The waterbody 130 of the aquaculture pond 112 may contain aquatic organisms intended for aquaculture. The waterbody 130 of the aquaculture pond 112 may, however, also be free or essentially free of aquatic organisms intended for aquaculture, e.g. in a state of preparation of the waterbody 130 for a subsequent introduction and breeding of aquatic organisms. The aquaculture pond 112 may further comprise dikes, walls or the like configured to enclose or contain the waterbody 130. The aquaculture pond 112 may, however, also be devoid of water 132 as illustrated in FIG. 2B. Thus, the aquaculture pond 112 may be drained, e.g. for a fallow period, for maintenance reasons for harvesting the farmed animals or for other reasons. Such drained aquaculture ponds 112 may be distinguishable from aquaculture ponds 112 filled with water, specifically in aerial sensor data, by a characteristic color or reflectance, as indicated in FIG. 2B by a stripe pattern. The aquaculture pond 112 may in particular have a rectangular or polygonal shape as indicated in FIGS. 2 and 3. The aquaculture pond 112 may specifically be situated in the open air. The aquaculture pond 112 and/or the aquaculture farm 114 as a whole may be visible from above as illustrated in FIGS. 2 and 3. The aquaculture pond 112 may specifically be used for growing one or more of shellfish or crustaceans, preferably shrimp and/or prawn.

Step a) of the method comprises obtaining, by the computer 110, the aerial parameter of use of at least one aquaculture pond 112 of at least one aquaculture farm 114. The aerial parameter of use may be determined by using aerial sensor data, specifically by using data acquired by at least one air-based sensor 134. The air-based sensor 134 may be located in an arbitrary aboveground position, such as on a satellite 136 as indicated in FIG. 2A, on an airplane or on a drone (not shown), where it may collect the aerial sensor data. FIG. 2A further illustrates with an arrow the receiving and/or retrieving of the aerial sensor data by the computer 110. The aerial sensor data may be acquired at a considerable distance from the aquaculture farm 114 or pond 112, such as at a distance in the range from 1 m to 50000 km, preferably from 20 m to 5000 km, more preferably from 30 m to 2000 km. Specifically, when located on a drone, the air-based sensor 134 may be movable or relocatable by controlling the drone. Additionally or alternatively, the air-based sensor 134 may be mounted on a support device that is in contact with the ground, such as a pole, a stake, a post or a pylon. The support device may be static or it may be movable or relocatable. The aerial sensor data may be or may comprise at least one image or at least one map. The image and the map acquired by the air-based sensor 134 may also be referred to as aerial image and aerial map, respectively.

The aerial parameter of use may be determined, specifically generated, by the computer 110. The aerial parameter of use may specifically be received or retrieved by the computer 110, e.g. from another electronic device, specifically a further computer. Specifically, the aerial parameter of use, may be determined, particularly generated, by the computer 110 on the basis of the aerial sensor data that may be interpreted or evaluated by the computer 110, specifically the processor 124, in a predetermined manner, such as by at least one algorithm. The aerial parameter of use of the aquaculture pond 112 may in particular comprise information regarding a property, quality, state or condition of the aquaculture pond 112 as well as a presence or absence of structures or elements relating to the use of the aquaculture pond 112. As an example, the aerial parameter of use of the aquaculture pond 112 may refer to the water level of the pond 112, e.g. whether the pond 112 is filled with water or whether it is drained 132. The parameter of use may further refer to the aeration status of the pond 112, e.g. the pond 112 being aerated, in particular at a certain intensity and/or by a certain aeration device 138, or not aerated. The aerial parameter of use may also refer to the presence or absence of the aeration devices 138 in a particular pond 112. The aerial parameter of use may further refer to the presence or absence of aquafarming infrastructure elements which may affect the use or usability of the aquaculture pond 112. Specifically, the parameter of use may refer to the presence or absence of channels 126, pipes, draines or reservoirs 140 in connection with the aquaculture pond 112, the use of a natural water body 130 as feed water source 142 or the common use of a feed water source 142 with a further aquaculture pond 112. FIG. 2B shows an aquaculture farm 114 comprising channels 126 to make use of the reservoir 140 as well as of the river 146 as feed water source 142 for its aquaculture ponds 112. The aerial parameter of use may refer to a location of the aquaculture pond 112 or its aquaculture farm 114, e.g. its exact geographic location or its location in at least one predetermined geographic region 116 or within at least one predefined distance to at least one reference point, such as a natural water body 130, a mountain 144 or a further aquaculture pond 112, e.g. of a further aquaculture farm 114. Such an information regarding the location of the aquaculture pond 112 may affect the use of the aquaculture pond 112 in numerous ways. Thus, as an example, an outbreak of disease at an aquaculture farm 114 may easily lead to infections at other aquaculture farms 114 in its close vicinity, in particular if common feed water sources 142 are used, such as a particular river 146, as illustrated in FIG. 2B. Further, weather conditions or other natural phenomena may usually have locally restricted effects, which may also influence aquaculture farms 114. The aerial parameter of use may in particular be selected from the group consisting of: the aquaculture pond 112 is filled with water; the aquaculture pond 112 is drained 132; the aquaculture pond 112 is aerated, specifically by using at least one aeration device 138, in particular at least one of a paddle wheel, an air blowing means, a bubble-generation device, an air jet device and a water jet device; the aquaculture pond 112 is active; the aquaculture pond 112 is filled with water and is essentially free of aquatic organisms intended for aquaculture; the aquaculture pond 112 uses a natural water body as feed water source, specifically at least one of a river 146 and the ocean 156; the aquaculture pond 112 is located in a predetermined geographic region, the aquaculture pond 112 is located within a predefined distance to at least one of a natural water body 130 and a mountain 144; the aquaculture pond 112 is located within a predefined distance to at least one further aquaculture pond 112; the aquaculture pond 112 shares a feed water source 142 with at least one further aquaculture pond 112, specifically a further aquaculture pond 112 of a further aquaculture farm 114. Other examples are feasible.

The aquaculture pond 112 may also be assigned a plurality of aerial parameters of use. As an example, a current status of the aquaculture pond 112 as indicated by its aerial parameters of use may comprise that it is aerated, that it is situated within a predefined distance to the sea 156, that it uses a nearby river 146 as feed water source 142 and that a further aquaculture pond 112 belonging to an aquaculture farm 114 located upstream of the river 146, also uses this river 146 as feed water source 142. Such a situation is schematically depicted in FIG. 2B (the sea 156 is not shown). The curved arrow indicates the movement of the aeration device 138, which may be discernable in aerial sensor data e.g. by a white color due to water turbulence and/or bubble formation. The aerial parameter of use may specifically be obtained, specifically derived, from at least one of the following: a color of the aquaculture pond 112; a reflectance of the aquaculture pond 112; a turbulence generated within the aquaculture pond 112, specifically a turbulence created by at least one aeration device 138 within the aquaculture pond 112 and more specifically a turbulence created by at least one paddle wheel within the aquaculture pond 112; air bubbles generated within the aquaculture pond 112, specifically air bubbles created by at least one aeration device 138 within the aquaculture pond 112; a connection of the aquaculture pond 112 to a feed water source 142, specifically a natural water body 130, specifically via at least one of water pipes, channels 126 and reservoirs 140; a geographic location of the aquaculture pond 112, specifically a proximity to a natural water body 130; the presence of at least one further aquaculture pond 112 in proximity to the aquaculture pond 112 whose aerial parameter of use is obtained; a connection of the aquaculture pond 112 to at least one further aquaculture pond 112, specifically via at least one of water pipes, channels 126 and reservoirs 140.

Step b) of the method comprises obtaining, by the computer 110, at least one regional management parameter of at least one region 116 regionally associated with the aquaculture farm 114. The regional management parameter may comprise information regarding a state, a condition, a property and/or an event that may affect the running, directing or organizing of the aquaculture farm 114, specifically the aquaculture pond 112. The state, condition, property and/or event may originate or become visible outside of the aquaculture farm 114. Aquaculture ponds 112, specifically those situated in the open air, may be exposed to a variety of external influences e.g. environmental influences, meteorological influences or natural phenomena, which may reduce the farming success or even spoil the farming efforts. As an example, the regional management parameter may refer to a meteorological situation or its effects such as wind conditions, rainfall, water level, tidal level or wave height, which may e.g. cause flooding. As a further example, the regional management parameter may refer to a state, a condition, a property or an event regarding an aquaculture pond 112 of a further aquaculture farm 114, e.g. a sup-posed or actual outbreak of a disease. Further examples of regional management parameters are feasible. The regional management parameter may for example be expressed or reflected in at least one measured value, a course of measured values, specifically a time course of measured values, a measurement curve or table of measured values. Additionally of alternatively, the regional measurement parameter may comprise information in the form of image data, such as aerial sensor data, and/or in verbal format such as in a text, for example a text from a newsfeed. Specifically, the regional management parameter may be selected from the group consisting of: a weather condition, specifically a presence, an absence or a duration of at least one of rainfall, hail, snow, storm, sunshine, clouds and fog; a weather-related measurand, specifically an amount of rain, hail or snow, a wind speed; a temperature; a change in temperature; a natural phenomenon, specifically a tidal level, a tide-dependent rise or fall of a water level, a wave formation, a wave height, a wave movement, a flood; a probable occurrence of a disease incidence, specifically at an aquaculture farm 114 or an aquaculture pond 112; an actual occurrence of a disease incidence, specifically at an aquaculture farm 114 or an aquaculture pond 112.

The obtaining of the regional management parameter in step b) may specifically comprise at least one of the following:
measuring the regional management parameter by using at least one regional management signal sensor 148, specifically at least one regional management signal sensor 148 selected from the group consisting of: a regional wind sensor; a regional environmental sensor 150; a regional meteorological sensor 152; a regional tidal sensor 154;
determining the regional management parameter from aerial sensor data, specifically at least one of satellite data and drone data, specifically aerial sensor data selected from the group consisting of: at least one aerial parameter of use of at least one other aquaculture pond 112 and/or at least one other aquaculture farm 114 in the region 116; aerial sensor data indicative of a meteorological situation in the region 116; aerial sensor data indicative of flooding in the region 116; and
retrieving the regional management parameter from at least one electronic source, specifically from at least one electronic source selected from the group consisting of: a data base; a newsfeed, specifically a newsfeed selected from the group consisting of a meteorological newsfeed, an environmental newsfeed, a flood warning newsfeed and a disease newsfeed; the world wide web.

In step b) the regional management parameter of the at least one region 116 is obtained. The at least one region 116 is regionally associated with the aquaculture farm 114. The region 116, which is regionally associated with the aquaculture farm 114, may border on the aquaculture farm 114 or may be situated distant from the aquaculture farm 114. In particular, the region 116, specifically a geographic location comprised by the region 116, which is regionally associated with the aquaculture farm 114, may be situated at a maximum distance or less from the aquaculture farm 114, wherein said maximum distance may be 1000 km, preferably 500 km, more preferably 200 km, more preferably 50 km and most preferably 10 km. Thus, a plurality of regions 116 may be regionally associated with a single aquaculture farm 114 as illustrated in FIG. 2A, wherein different regions 116 regionally associated with one particular aquaculture farm 114 are demarcated with different dashed lines. Such regions 116 may cover areas at distinct geographical sites and/or with distinct properties, such as one region 116 comprising the course of a river 146 as shown in FIG. 2A. The river may e.g. function as feed water source 142 and/or pass in close vicinity to the aquaculture farm 114. Another region 116 may comprise the sea 156 and/or a costal region close to the aquaculture farm 114. Another region 116 may comprise at least one further aquaculture farm 114 in vicinity to the aquaculture farm 114 in question, as also indicated in FIG. 2A. Further regions 116 regionally associated with the aquaculture farm 114 are feasible. The regions 116 regionally associated with the aquaculture farm 114 may particularly comprise at least one regional management signal sensor 148 as illustrated in FIG. 2A. Specifically, FIG. 2A shows, in an exemplary fashion, one regional environmental sensor 150 located in the river 146, one regional tidal sensor 154 located in the sea 156 and one regional meteorological sensor 152 located in the mountains 144. The arrows between the regional management signal sensors 148 and the computer 110 in FIG. 2A indicate the receiving and/or retrieving of the regional management parameter by the computer 110. The regional management parameter may, however, may also be obtained using aerial sensor data and/or on the basis of information obtained from an electronic source as already described above.

Step c) of the method comprises determining, by the computer 110, at least one management demand signal for the aquaculture pond 112 on the basis of the aerial parameter of use and the regional management parameter. Specifically, for determining the management demand signal, the computer 110 may evaluate and/or interpret data and/or information comprised by the aerial parameter of use and data and/or information comprised by the regional management parameter. Evaluation and/or interpretation may take place by applying at least one algorithm to the aerial parameter of use and the regional management parameter. As part of determining the management demand signal, the management demand signal may in particular be chosen from a predetermined data set of management demand signals in a predetermined manner, such as according to the algorithm. The management demand signal may comprise information regarding the aquaculture farm management. Specifically, the management demand signal may identify, indicate or suggest at least one aquaculture pond management action. In particular the management demand signal may comprise information on potentially beneficial changes in the aquaculture farm management such as on possible adjustments of at least one parameter of the aquaculture farm 114 or pond 112 e.g. feeding, water quality, harvest time or use of floodgates 158. The management demand signal may specifically comprise control information on at least one of the following aquaculture pond management actions: an adjustment of feed composition; an adjustment of feed amount; an adjustment of feed timing; an adjustment of medication dispensation; an adjustment of aeration; an adjustment of filtration; an adjustment of salinity; an adjustment of water flow; an adjustment of influx volume; an adjustment of outflux volume; an adjustment of timing of animal release into the aquaculture pond; an adjustment of harvest time, specifically a harvesting of the aquaculture pond 112 at a predetermined time or in a predetermined time range; an adjustment of a status of at least one tide gate or floodgate 158, specifically a closure or an opening of the tide gate or floodgate 158; an adjustment of a feed water source 142, specifically a change of a feed water source 142 from a natural water body 130 like a river 146 to a reservoir 140 or vice versa; a use or removal of at least one protection device, specifically at least one covering device.

The following examples may illustrate different embodiments of the aquaculture farm management method. Thus, as an example, the computer 110 may obtain in step a) of the method a plurality of aerial parameters of use of a particular aquaculture pond 112. A first aerial parameter of use may indicate that a particular aquaculture pond 112 uses a particular river 146 as feed water source 142. A second aerial parameter of use of the pond 112 may further indicate the presence of floodgates 158. The regional management parameter obtained in step b) may comprise information on rainfalls in a region 116 regionally associated with the aquaculture farm 114, said region comprising the river 146 or part of its course. The computer 110 determining the management demand signal may evaluate the information, e.g. by comparing the measured rainfall to at least one threshold value. In case the threshold value is exceeded a management demand signal may be generated in step c) for the aquaculture pond 112 using the river 146 as feed water source 142. The management demand signal may comprise instructions to a user to close the floodgate 158. Additionally of alternatively, the management demand signal may comprise control information for a control device 160, which may prompt the closing of an automated floodgate 158.

In a further example illustrating an embodiment of the aquaculture farm management method, the computer 110 may obtain in step a) of the method a plurality of aerial parameters of use of a particular aquaculture pond 112. A first aerial parameter of use of the pond 112 may comprise information indicating that the particular aquaculture pond 112 may be situated in vicinity to a further aquaculture farm 114. A second aerial parameter of use of the pond 112 may indicate that the particular aquaculture pond 112 and the further aquaculture farm 114 share the same river 146 as feed water source 142. FIG. 2B illustrates a situation as described in this example. The regional management parameter obtained by the computer 110 in step b) may be the aerial parameter of use of one or several aquaculture ponds 112 of the further aquaculture farm 114, in particular a time series of the aerial parameter of use of the one or several aquaculture ponds 112 of the further aquaculture farm 114. The regional management parameter may comprise information on a probable occurrence of a disease at the further aquaculture farm 114, e.g. as deduced from aerial sensor data indicating a sudden and/or unexpected draining of the aquaculture ponds 112 of the further aquaculture farm 114. FIG. 2B shows the aquaculture ponds 112 of the further aquaculture farm 114 in a drained state 132 as indicated by the stripe pattern. The management demand signal determined by the computer 110 in step c) may comprise instructions to a user to disconnect the aquaculture pond 112 from the river 146, e.g. by closing floodgates 158. Further management demand signals determined by the computer 110 may comprise at least one instruction, particularly a handling suggestion, regarding management actions to increase a resilience and/or vitality of the farmed animals or plants, e.g. by increasing an oxygen supply, a change of feed, an administration of drugs, and/or measures for the killing of germs.

The aquaculture farm management method may comprise steps additional to steps a), b) and c). In particular, the method may comprise:
d) providing, to at least one control device 160, specifically at least one control device 160 of the aquaculture farm 114, the management demand signal.

The method may further comprise:
e) automatically controlling the control device 160 according to the management demand signal.

The method may specifically comprise:
f) informing a user, by at least one user device 162 of the control device 160, about the management demand signal.

FIG. 1B shows a flow chart of the aquaculture farm management method in an embodiment further comprising steps d), e) and f). In the flow chart of FIG. 1B, step d) is represented by reference sign 164, step e) is represented by reference sign 166 and step f) is represented by reference sign 168. The control device 160 may be located at the aquaculture farm 114. The control device 160 may specifically be or comprise at least one computer. The control device 160 may specifically comprise a user device 162, e.g. a display 170 or a screen as shown in FIG. 2B. Specifically, in step f) the user may be informed about the management demand signal by displaying the management demand signal on the display 170. Step f) may particularly comprise instructing the user for performing at least one action according to the management demand signal. The user may be instructed e.g. by providing guidance to the user by an augmented reality element of the user device 162, such as by a virtual reality headset, e.g. by superimposing guidance information in a field of view of the user. As an example, the user may receive information by the augmented reality element regarding the adjustment of control elements, such as a button that needs to be pressed or a cog that needs to be turned, to perform a management action in accordance with the management demand signal, such as the closing of the floodgate 158.

The control device 160 may comprise at least one actuator device 172. The control device 160 may receive the management demand signal comprising control information adapted to automatically control the control device 160, specifically the actuator device 172. In FIG. 2B a double sided arrow illustrates a connection between the computer 110 and the control device 160, specifically a wireless connection, which may be used for transmitting the control information from the computer 110 to the control device 160. A data transmission using a physical connection may also be possible. A large variety of actuator devices 172 is feasible. In particular, the control device 160 may comprise at least one actuator device 172 selected from the group consisting of: an automated feeding device 128; an automated medication dispenser device; an automated aeration device 138; an automated tide gate or floodgate 158; an automated measuring and sorting device, such as a biomass and animal measuring and sorting device; an automated cleaning device, such as a pond or vessel cleaning device; an automated drainage device, e.g. a central drainage device; a water exchange device; an automated pump device, such as a pumping for water exchange and a pumping for water circulation rate; an automated injector device, such as injector devices for gas, water or mixtures thereof; an automated bubble creation or dosing device, such as a nanobubble or microbubble creation or dosing device; an automated harvester, such as an automated harvester for fully or partially harvesting biomass; an automated water movement device; an automated shading device, such as a shading device for fully or partially excluding sunlight; an automated device for dosing of living agents, such as for probiotics, microbiome constituents, algae, microorganisms, bacteria, viruses, phages or fungi; an automated sensor, such as a device for testing of presence, species and frequency of microbiome constituents, algae, microorganisms, bacteria, viruses, phages or fungi; an automated feeding device 128, such as a device for adaption of diets fed, a device for adaption of feeding inputs, e.g. from a set of feed reservoirs, a device for feeding at adapted rates, a device for feeding with adapted physical parameters for the distribution of the feed, such as radius, speed and frequency of feed dosing; an automated water parameter measuring sensor, e.g. a device for measurement of water parameters comprising one or more of pH, temperature, dissolved oxygen, salinity and redox potential; an automated water parameter adaption device, e.g. a device for measurement and adaption of water parameters comprising one or more of pH, temperature, dissolved oxygen, salinity and redox potential; an automated animal interaction device, such as a device for hiding, resting or feeding for the animals in pond or vessel.

FIG. 2B illustrates the use of such actuator devices 172 in the form of an automated floodgate 158, an automated feeding device 128 and an automated aeration device 138, which may be controlled by the control device 160. Thus, the management demand signal may be used for controlling at least one automated process by controlling the actuator device 172 of the control device 160 in the absence of user interaction. Additionally or alternatively, the management demand signal may be addressed to at least one user and may suggest or recommend at least one user action, particularly the at least one aquaculture pond management action.

The method may further comprise:
g) obtaining, by the computer 110, at least one local sensor parameter from at least one local sensor device 174 locally associated with the aquaculture farm 114.

The management demand signal in step c) may be determined by further taking into account the local sensor parameter. The local sensor device 174 may be located at the aquaculture farm 114 as shown in FIG. 2B. The local sensor device 174 may be a ground-based sensor device or a water-based sensor device, specifically an underwater sensor as shown in FIGS. 2 and 3. The local sensor device 174 may in particular comprise at least one of: a chemical sensor, specifically a chemical sensor for the analysis of water quality, more specifically a chemical sensor configured to detect at least one of oxygen concentration, chemical oxygen demand, biochemical oxygen demand, nitrogen concentration, phosphorus concentration and salinity; a camera, specifically a camera with at least one image sensor; a temperature sensor, a flowmeter; a rain gauge; a wind gauge; a water level indicator; a photometer; a fluorescence meter. The local sensor device 174 may be configured to measure the local sensor parameter. FIG. 2A illustrates with an arrow pointing from the local sensor device 174 to the computer 110 the receiving and/or retrieving of the local sensor parameter. A large variety of local sensor parameters is feasible. The local sensor parameter may specifically be selected from the group consisting of: water quality, preferably any of dissolved oxygen content, oxygen concentration, chemical oxygen demand, biochemical oxygen demand, temperature, salinity, chlorophyll intensity, chlorophyll concentration, turbidity, nitrogen content, nitrogen concentration, phosphorus content, phosphorus concentration; water movement, preferably any of flow volume, turbulence; pond status, preferably any of pond fill level, aeration intensity, influx volume, outflux volume; farmed animal status, preferably any of animal size, food consumption amount, food consumption frequency, mobility, pathogen pressure; environment status, preferably any of measured rainfall, measured temperature, tidal level, wind speed, sunshine duration, feed water level, feed water quality, feed water current direction and/or intensity.

Step c) of the aquaculture farm management method may specifically comprise determining at least one discrepancy signal using the aerial parameter of use and the regional management parameter. In particular, the discrepancy signal may comprise information regarding a difference between the aerial parameter of use and the regional management signal, specifically a difference between an actual property, quality state or condition of the aquaculture pond and/or its infrastructure and a property, quality state or condition of the aquaculture pond and/or its infrastructure that may be desirable when taking into account the regional management signal. Specifically, step c) may comprise determining, by the computer 110, the management demand signal on the basis of the discrepancy signal.

Step a) may further comprise determining, by the computer 110, a temporal development of the aerial parameter of use on the basis of a time series of aerial parameters of use obtained by the computer 110. Further, the determining of the management demand signal on the basis of the aerial parameter of use and the regional management parameter may take into account the temporal development of the aerial parameter of use. Such a time series may specifically identify a sudden and/or unexpected and/or simultaneous draining of aquaculture ponds 112 belonging to at least one aquaculture farm 114 in one of the regions 116 regionally associated with the aquaculture pond 112, on which the aquaculture farm management method of is performed. The sudden and/or unexpected and/or simultaneous draining of aquaculture ponds 112 may specifically indicate the occurrence of disease as already described, e.g. in one of the examples given above. Further, step b) may comprise determining, by the computer 110, a temporal development of the regional management parameter on the basis of a time series of regional management parameters obtained by the computer 110. Specifically, the determining of the management demand signal on the basis of the aerial parameter of use and the regional management parameter may take into account the temporal development of the regional management parameter.

The method may comprise acquiring aerial sensor data, specifically at least one map or image of aerial sensor data, more specifically a sequence of aerial sensor data, wherein step a) may further comprise assigning the at least one aerial parameter of use to the aquaculture pond 112 by using the aerial sensor data. The aerial parameter of use may specifically be assigned to the aquaculture pond 112 by applying at least one evaluation algorithm to the aerial sensor data. The method may specifically comprise identifying the at least one aquaculture pond 112 in at least one aerial image, specifically in at least one aerial image from which the at least one aerial parameter of use is derived. The method may particularly comprise identifying at least one further aquaculture pond 112 in the at least one aerial image, specifically in at least one aerial image from which the regional management parameter is derived. The aerial parameter of use and the regional management parameter may be derived from the same aerial image.

The method may specifically be carried out for a plurality of aquaculture farms 114 simultaneously, such as for two aquaculture farms 114 as shown in FIG. 2B or for more than two aquaculture farms 114, such as at least 20, preferably at least 50, more preferably at least 100 aquaculture farms 114. The plurality of aquaculture farms 114 may in particular have at least one region 116 in common that is regionally associated with each of the plurality of aquaculture farms 114. Specifically, at least one common regional management parameter may be obtained for the plurality of aquaculture farms 114. For each aquaculture farm 114 at least one aerial parameter of use of at least one of the aquaculture ponds 112 may be obtained.

Further, in step a) the at least one aerial parameter of use may be obtained for the at least one aquaculture pond 112 at a predetermined frequency. The predetermined frequency, at which the at least one aerial parameter of use may be obtained, may in particular be in the range of once per hour to once per 5 days, preferably once per 2 hours to once per 3 days. Specifically, in step b) the at least one regional management parameter may be obtained at a predetermined frequency. The predetermined frequency, at which the regional management parameter may be obtained, may be in the range of once per hour to once per 5 days, preferably once per 2 hours to once per 3 days. Further, the aerial parameter of use and the regional management parameter may be obtained at the same predetermined frequency.

Step b) may further comprise comparing the regional management parameter with at least one reference parameter. In particular, in step c) the management demand signal may be determined depending on the comparison of the regional management parameter with the at least one reference parameter. On the basis of the comparison with the at least one reference parameter, information on at least one potential risk for the aquaculture pond 112 whose parameter of use is obtained may be generated, specifically information on at least one of: a risk of flooding; a risk of salinity intrusion; a risk of storm damage; a risk of temperature change; a risk of a drop in feed water quality; a risk of disease introduction. In step c) the management demand signal may be determined in such a way as to avoid, reduce or minimize the potential risk for the aquaculture pond 112. The reference parameter may particularly comprise at least one of the following: a single reference parameter, a reference parameter range; a reference parameter table; at least one threshold parameter value. The reference parameter may specifically depend on at least one of the following: a location of the aquaculture pond 112; a season of the year.

In a further aspect of the present invention, an aquaculture farm management system 176 for managing at least one aquaculture farm 114 having at least one aquaculture pond 112 is proposed. The aquaculture farm management system 176 is illustrated in FIG. 2B. The aquaculture farm management system 176 comprises at least one computer 110 configured for obtaining at least one aerial parameter of use of at least one aquaculture pond 112 of at least one aquaculture farm 114, wherein the computer 110 is further configured for obtaining at least one regional management parameter of at least one region 116 regionally associated with the aquaculture farm 114, wherein the computer 110, specifically at least one processor 124 of the computer 110, is furthermore configured for determining at least one management demand signal for the aquaculture pond 112 on the basis of the aerial parameter of use and the regional management parameter.

The processor 124 may further be configured for obtaining one or both of the aerial parameter of use and the regional management signal. Specifically, the computer 110 may obtain one or both of the aerial parameter of use and the regional management parameter by receiving the one or both of the aerial parameter of use and the regional management parameter, such as from a further electronic device, specifically a computer 110, e.g. via at least one interface 178. In particular, the computer 110 may receive aerial sensor data, e.g. from the air-based sensor 134 of the satellite 136 via the interface 178, as illustrated by the arrow in FIG. 2A. The computer 110, specifically the processor 124, may be configured for assigning the aerial parameter of use to the aquaculture pond 112 by applying at least one evaluation algorithm to the aerial sensor data. The computer 110 may be configured for identifying the at least one aquaculture pond 112 in at least one aerial image, specifically at least one aerial image from which the at least one aerial parameter of use is derived. The computer 110 may be configured for comparing the regional management parameter with at least one reference parameter. The aquaculture farm management system 176 may further comprise at least one database comprising the at least one reference parameter. Specifically, the computer 110 may be configured for generating information on at least one potential risk for the aquaculture pond 112, whose parameter of use is obtained, on the basis of the comparison with the reference parameter. The aquaculture farm management system 176 may further comprise a storage element 180. The storage element 180 may specifically be configured for storing at least one data element, such as at least one piece of data in electronic form. In particular, at least one of the following may be stored on the storage element 180: the at least one aerial parameter of use; the at least one regional management parameter; the at least one management demand signal; a time course of the aerial parameter of use; a time course of the regional management parameter; a time course of the management demand signal; the aerial sensor data; the reference parameter.

The aquaculture farm management system 176 may comprise at least one transmitter 182 for transmitting the management demand signal to at least one predefined location remote from the computer 110, specifically to a location close to the aquaculture pond 112 whose aerial parameter of use is obtained, such as to at least one further electronic device, specifically to a computer and/or a control device 160, located at the aquaculture farm 114. Different ways and methods of transmission, specifically wireless transmission, are feasible. The use of a physical connection for data transfer is also possible. The aquaculture farm management system 176 may comprise the control device 160. The control device 160 may be configured for being controlled according to the management demand signal in an automated fashion, e.g. automatically. The control device 160 may comprise at least one actuator device 172 and/or at least one user device 162. The user device 162 may comprise at least one display 170 configured for displaying the management demand signal. In particular, the user device 162 may be configured for informing the user about the management demand signal, e.g. via the display 170 as illustrated in FIG. 3. The user device 162 may particularly comprise an augmented reality element (not shown in the Figures) configured to instruct the user to perform at least one action according to the management demand signal. The control device 160 may comprise the at least one actuator device 172. FIG. 3 illustrates in an exemplary fashion the use of different actuator devices 172, specifically automated floodgates 158, the automated feeding device 128 and the automated aeration device 138. The actuator devices 172 may be controlled by the control information. The aquaculture farm management system 176 may comprise at least one local sensor device 174 locally associated with the aquaculture farm 114 configured for determining at least one local sensor parameter. FIG. 3 illustrates the use of two local sensor devices 174 each measuring an oxygen concentration of one of the aquaculture ponds 112.

### LIST OF REFERENCE NUMBERS

110 computer
112 aquaculture pond
114 aquaculture farm
116 region
118 step a)
120 step b)
122 step c)
124 processor
126 channel
128 feeding device
129 pump
130 waterbody
132 devoid of water
134 air-based sensor
136 satellite
138 aeration device
140 reservoir
142 feed water source
144 mountain
146 river
148 regional management signal sensor
150 regional environmental sensor
152 regional meteorological sensor
154 regional tidal sensor
156 sea
158 floodgate
160 control device
162 user device
164 step d)
166 step e)
168 step f)
170 display
172 actuator device
174 local sensor device
176 aquaculture farm management system
178 interface
180 storage element
182 transmitter

1. A computer-implemented aquaculture farm management method, comprising
a) obtaining, by at least one computer, at least one aerial parameter of use of at least one aquaculture pond of at least one aquaculture farm, wherein step a) further comprises determining, by the computer, a temporal development of the aerial parameter of use on the basis of a time series of aerial parameters of use obtained by the computer;
b) obtaining, by the computer, at least one regional management parameter of at least one region regionally associated with the aquaculture farm; and
c) determining, by the computer, at least one management demand signal for the aquaculture pond on the basis of the aerial parameter of use and the regional management parameter,
wherein the determining of the management demand signal on the basis of the aerial parameter of use and the regional management parameter takes into account the temporal development of the aerial parameter of use,
wherein the aerial parameter of use is obtained from at least one of the following: a color of the aquaculture pond; a reflectance of the aquaculture pond; a turbulence generated within the aquaculture pond; air bubbles generated within the aquaculture pond; a connection of the aquaculture pond to a feed water source; a geographic location of the aquaculture pond; the presence of at least one further aquaculture pond in proximity to the aquaculture pond whose aerial parameter of use is obtained; or a connection of the aquaculture pond to at least one further aquaculture pond, and
wherein the aerial parameter of use is selected from the group consisting of: the aquaculture pond is filled with water; the aquaculture pond is drained; the aquaculture pond is aerated; the aquaculture pond is active; the aquaculture pond is filled with water and is essentially free of aquatic organisms intended for aquaculture; the aquaculture pond uses a natural water body as feed water source; the aquaculture pond is located in a predetermined geographic region, the aquaculture pond is located within a predefined distance to at least one of a natural water body and a mountain; the aquaculture pond is located within a predefined distance to at least one further aquaculture pond; and the aquaculture pond shares a feed water source with at least one further aquaculture pond.

2. The method according to claim 1, wherein the management demand signal comprises control information on at least one of the following aquaculture pond management actions: an adjustment of feed composition; an adjustment of feed amount; an adjustment of feed timing; an adjustment of medication dispensation; an adjustment of aeration; an adjustment of filtration; an adjustment of salinity; an adjustment of water flow; an adjustment of influx volume; an adjustment of outflux volume; an adjustment of timing of animal release into the aquaculture pond; an adjustment of harvest time; an adjustment of a status of at least one tide gate or floodgate; an adjustment of a feed water source; or a use or removal of at least one protection device.

3. The method according to claim 1, further comprising
d) providing, to at least one control device the management demand signal.

4. The method according to claim 3, further comprising
e) automatically controlling the control device according to the management demand signal.

5. The method according to claim 3, further comprising
f) informing a user, by at least one user device of the control device, about the management demand signal.

6. The method according to claim 3, wherein the control device comprises at least one actuator device.

7. The method according to claim 1, wherein the obtaining of the regional management parameter in step b) comprises at least one of the following:
measuring the regional management parameter by using at least one regional management signal sensor;
determining the regional management parameter from aerial sensor data; and
retrieving the regional management parameter from at least one electronic source.

8. The method according to claim 1, the method further comprising
g) obtaining, by the computer, at least one local sensor parameter from at least one local sensor device locally associated with the aquaculture farm wherein the management demand signal in step c) is determined by further taking into account the local sensor parameter.

9. The method according to claim 1, wherein step b) further comprises comparing the regional management parameter with at least one reference parameter, wherein in step c) the management demand signal is determined depending on the comparison of the regional management parameter with the at least one reference parameter.

10. The method according to claim 1, wherein step b) further comprises determining, by the computer, a temporal development of the regional management parameter on the basis of a time series of regional management parameters obtained by the computer, wherein the determining of the management demand signal on the basis of the aerial parameter of use and the regional management parameter takes into account the temporal development of the regional management parameter.

11. A computer program comprising computer-executable instructions for performing the method according to claim 1 when the program is executed on a computer or computer network.

12. A computer or computer network comprising at least one processor, wherein the processor is adapted to perform the method according to claim 1.

13. A computer-readable storage medium having stored thereon the computer program according to claim 11.

14. An aquaculture farm management system for managing at least one aquaculture farm having at least one aquaculture pond, the aquaculture farm management system comprising at least one computer configured for obtaining at least one aerial parameter of use of at least one aquaculture pond of at least one aquaculture farm, wherein the computer is further configured for obtaining at least one regional management parameter of at least one region regionally associated with the aquaculture farm, wherein the computer is furthermore configured for determining at least one management demand signal for the aquaculture pond on the basis of the aerial parameter of use and the regional management parameter.

15. (canceled)

16. (canceled)
